(19) United States
(12) Patent Application Publication
(10) Pub. No.: US 2011/0109651 A1
(43) Pub. Date: May 12, 2011

(54) METHODS AND SYSTEMS FOR DETERMINING EFFICACY OF MEDICAMENTS

(76) Inventors: David Fairlamb, Manchester (GB); Mark William James Ferguson, Manchester (GB); Tracey Mason, Manchester (GB); Sharon O'Kane, Manchester (GB); Ann Helena Ledwith, Manchester (GB)

(21) Appl. No.: 13/002,029

(22) PCT Filed: Jun. 15, 2009
(86) PCT No.: PCT/GB09/01508

§ 371 Date: Dec. 29, 2010

(30) Foreign Application Priority Data
Jul. 1, 2008 (GB) 0812003.2

(51) Int. Cl. G06T 7/00; G09G 5/00

(52) U.S. Cl. 345/634; 382/128

(57) ABSTRACT

A method and apparatus for determining the efficacy of a medicament for the treatment of wounds or scars. The method comprises selecting first and second scarring site portions wherein said first scarring site portion has been treated with said medicament. A pair of images comprising a first image of said first scarring site portion and a second image of said second scarring site portion is generated, and the pair of images is displayed. A recording element comprising first and second recording portions is provided, wherein said first recording portion comprises a plurality of first points indicating that scarring in said first image is less severe than scarring in said second image, and said second recording portion comprises a plurality of second points indicating that scarring in said second image is less severe than scarring in said first image, each of said first and second points having different associated values. Data identifying one of said points is received and used to determine the efficacy of said medicament.

The present invention relates to methods and systems for determining the efficacy of a medicament intended to reduce scarring in human or animal skin. The invention also relates to methods and systems for collecting data relating to an image, such as an image of human or animal skin including a scar.

It is well known that methods are required to determine the effectiveness of medicaments. Typically, a new medicament is initially tested on animals before being tested on humans. Tests on humans often involve dividing a group of humans suffering from a condition which it is desired to treat into two sub groups. A first sub group is provided with a placebo (i.e. a substance having no therapeutic affect), and a second group is provided with the medicament the effectiveness of which is to be tested. By comparing symptoms within the first and second sub groups, the effectiveness of the medicament as compared to the placebo can be determined.

Methods of measuring medicament effectiveness are highly dependent upon the condition which is to be treated. For some conditions an objective measure of effectiveness can easily be derived. For example, if a medicament is intended to reduce cholesterol levels, taking cholesterol readings of the patients in the first and second sub groups will determine the effectiveness of the medicament. In other cases such an objective measure cannot easily be derived. One example of such a case is an assessment of the effectiveness of a medicament for promoting wound healing and/or reducing scarring, which assessment is at least partially subjective.

The term “wound” is exemplified by, but not limited to, injuries to the skin. Other types of wound can involve damage, injury or trauma to an internal tissue or organ such as the lung, kidney, heart, gut, tendons or liver.

The response to wounding is common throughout all adult mammals. It follows the same pattern, and leads to the same result, formation of a scar. Many different processes are at work during the healing response, and much research has been conducted into discovering what mediates these processes, and how they interact with each other to produce the final outcome.

The healing response arises as the evolutionary solution to the biological imperative to prevent the death of a wounded animal. Thus, to overcome the risk of mortality due to infection or blood loss, the body reacts rapidly to repair the damaged area, rather than attempt to regenerate the damaged tissue.

A scar may be defined as the structure produced as a result of the reparative response. Since the injured tissue is not regenerated to attain the same tissue architecture present before wounding, a scar may be identified by virtue of its abnormal morphology as compared to unwounded tissue. Scars are composed of connective tissue deposited during the healing process. A scar may comprise connective tissue that has an abnormal organisation (as seen in scars of the skin) and/or connective tissue that is present in an abnormally increased amount (as seen in scars of the central nervous system). Most scars consist of both abnormally organised and excess connective tissue.

The abnormal structure of scars may be observed with reference to both their internal structure (which may be determined by means of microscopic analysis) and their external appearance (which may be assessed macroscopically).

Extracellular matrix (ECM) molecules comprise the major structural component of both unwounded and scarred skin. In unwounded skin these molecules form fibres that have a characteristic random arrangement that is commonly referred to as a “basket-weave”. In general the fibres observed within unwounded skin are of larger diameter than those seen in scars. Fibres in scars also exhibit a marked degree of alignment with each other as compared to the fibres of unwounded skin. Both the size and arrangement of ECM may contribute to scars' altered mechanical properties, most notably increased stiffness, when compared with normal, unwounded skin.

Viewed macroscopically, scars may be depressed below the surface of the surrounding tissue, or elevated above the surface of the undamaged skin. Scars may be relatively darker coloured than the unwounded tissue (hyperpigmentation) or may have a paler colour (hypopigmentation) than their surroundings. Scars may also be redder than the surrounding skin. Either hyperpigmented or hypopigmented or redder scars constitute a readily apparent cosmetic defect. It has been shown that the cosmetic appearance of a scar is one of the major factors contributing to the psychological impact of wounds upon the sufferer, and that these effects can remain long after the wound itself has healed.

Scars may also have deleterious physical effects upon the sufferer. These effects typically arise as a result of the mechanical differences between scars and unwounded skin. The abnormal structure and composition of scars mean that they are typically less flexible than normal skin. As a result scars may be responsible for impairment of normal function (such as in the case of scars covering joints which may restrict the possible range of movement) and may retard normal growth if present from an early age.

The effects outlined above may all arise as a result of the normal progression of the wound healing response. There are, however, many ways in which this response may be abnormally altered; and these are frequently associated with even more damaging results.

One way in which the healing response may be altered is through the production of abnormal excessive scarring. Hypertrophic scars represent a severe form of scarring, and hypertrophic scars have marked adverse effects on the sufferer. Hypertrophic scars are elevated above the normal surface of the skin and contain excessive collagen arranged in an abnormal pattern. As a result such scars are often associated with a marked loss of normal mechanical function. This may be exacerbated by the tendency of hypertrophic scars to undergo contraction after their formation, an activity normally ascribed to their abnormal expression of muscle-related proteins (particularly smooth-muscle actin). Children suffer from an increased likelihood of hypertrophic scar formation, particularly as a result of burn injuries.

Keloids are another common form of pathological scarring. Keloid scars are not only elevated above the surface of the skin but also extend beyond the boundaries of the original injury. Keloids contain excessive connective tissue that is organised in an abnormal fashion, normally manifested as whirls of collagenous tissue. The causes of keloid formation are open to conjecture, but it is generally recognised that some individuals have a genetic predisposition to their formation. Both hypertrophic scars and keloids are particularly common in Afro-Caribbean and Mongoloid races.

Whilst the above considerations apply primarily to the effects of wound healing in humans, it will be appreciated that the wound healing response, as well as its disadvantages and potential abnormalities, is conserved between most species of animals. Thus the problems outlined above are also applicable to non-human animals, and particularly veterinary or domestic animals (e.g. horses, cattle, dogs, cats etc). By way of example, it is well known that adhesions resulting from the inappropriate healing of abdominal wounds constitute a major reason for the veterinary destruction of horses (particularly race horses). Similarly the tendons and ligaments of domestic or veterinary animals are also frequently subject to injury, and healing of these injuries may also lead to scarring associated with increased animal mortality.

From the preceding discussion, it will be appreciated that there is a need for a method of measuring the effectiveness of wound healing and scar reduction medicaments. Given that some of the disadvantageous effects of scars are psychological and based upon human perception of a scar, there is no objective chemical or biochemical test which can properly determine the effectiveness of a scar reduction therapy in overcoming such psychological effects. Indeed, an important indicator in assessing scar reduction is the subjective response to scars which have been treated with the medicament as compared to scars which have not been treated with that medicament. This problem is sometimes complicated by the fact that scar reduction therapies are often tested on volunteers who are wounded in a clinical test and then have the medicament applied to them. Therefore, the scar which is being improved is often one created for the purposes of the clinical test.

It is known to use visual analogue scoring to measure severity of scarring. This is achieved by showing an assessor a plurality of scars and asking that they indicate on a scale extending from a low value to a high value the severity of each scar. Marks marked on the scale are then converted to scores to determine the relative perceived severity of scarring in each scar. By using this technique with scars which have and have not been subjected to the medicament, a measure of medicament effectiveness can be derived.

Although visual analogue scoring does provide valuable data, it is not without its disadvantages. More specifically, it is often difficult for an assessor to determine a point on the scale which should be marked in response to a particular scar given that the assessor is only presented with that scar, making it impossible to compare scarring in the particular scar with scarring more generally.

This problem has been partially solved by associating reference images with points on the visual analogue scale. Such reference images allow an assessor to better determine a point on the scale which should be marked in response to a particular scar, based upon a comparison between the reference images and the particular scar.

While the use of reference images in connection with a visual analogue scale provides benefits, problems remain. First, given that skin tone varies markedly between human beings (even between human beings in a particular racial group), a large number of sets of reference images are required if the reference images are to be useful in the assessment of scars in a range of subjects. For example, the effects of redness and/or hyperpigmentation can significantly affect the way in which scars are perceived and therefore assessed.

Moreover, the scars from any one particular surgery type commonly fall within a small range of the entire visual analogue scale, meaning that typically, only 20-50% of the length of the scale is actually used. This is not unsurprising since the visual analogue scale was deliberately designed to cover the full range of scar severities, i.e. imperceptible scars (0 mm) through to very poor hypertrophic scars (100 mm). Although statistically significant improvements have been determined across the scale resulting from drug treatment, these are typically in the order of 4-10 mm. Such small improvements, despite being both statistically significant and rated as clinically significant by clinical panels, have proved to be problematic when communicating the effectiveness of drug treatment both to clinicians and lay people. Specifically, since only a small portion of the scale is used in any one particular clinical trial, a 4-10 mm shift in the value produced using the visual analogue scoring method may result in a considerable discrepancy with regard to percentage improvement, depending on the portion of the scale used. For example a 10 mm improvement caused by a drug at a lower end of the scale (e.g. 10 mm score for a drug treated scar and a 20 mm score for a control treated scar) will result in a high percentage improvement (i.e. 50%). In contrast the same 10 mm improvement at an upper end of the scale (e.g. a 80 mm score for a drug treated scar and a 90 mm score for a control treated scar) will only result in an improvement of some 11%. This discrepancy in percentage improvements is entirely unrelated to the effectiveness of the drug treatment, but is instead a consequence of the way in which data is obtained, resulting in percentage improvements which are not consistent across the length of the scale.

Tests have also shown that at low values on the scale, particularly below 35 mm (i.e. very good scars) it is more difficult to achieve clinically meaningful improvements using the anchored visual analogue scoring method, since the room for further improvement on the visual analogue scoring scale itself is very small and many of the improvements observed become lost in the noise of the scale.

Therefore, while it has been found that a visual analogue scoring method provides useful data, there remains a need for a scoring method that can be used as an alternative to, or in addition to, the visual analogue scoring method.

Furthermore, there is a need to provide convenient methods for the collection of data relating to scars.

It is an object of the present invention to obviate or mitigate at least some of the problems outlined above.

Aspects of the present invention provide methods and systems useful in determining the efficacy of medicaments intended to treat wounds or scars, for example medicaments intended to reduce scarring, or improve the rate of wound healing Aspects of the invention therefore provide methods and systems for collecting data indicating the severity of scarring. Such data may comprise data referred to as scoring data, and may indicate a comparison between severity of scarring of two scars. Aspects of the invention further provide novel methods for obtaining data indicating the severity of scarring, particularly for obtaining data indicating a comparison between the severity of scarring in two images.

According to a first aspect of the invention, there is provided a method of determining the efficacy of a medicament for the treatment of wounds or scars, for example a medicament for preventing scarring resulting from a wound, or improving the appearance of existing scars. The method comprises selecting first and second scarring site portions wherein said first scarring site portion has been treated with said medicament. A pair of images comprising a first image of said first scarring site portion and a second image of said second scarring site portion is generated, and the pair of images is displayed. A recording element comprising first and second recording portions is provided, wherein said first recording portion comprises a plurality of first points indicating that scarring in said first image is less severe than scarring in said second image, and said second recording portion comprises a plurality of second points indicating that scarring in said second image is less severe than scarring in said first image, each of said first and second points having different associated values. Data identifying one of said points is received and used to determine the efficacy of said medicament.

The methods described herein have particular application in comparing a first image of a first scar which has been treated with a medicament, and a second image of a second scar which has not been treated with that medicament. For example, the second scar may be untreated or may be treated with a placebo (i.e. a substance having no therapeutic effect) or with some other control treatment.

According to a second aspect of the invention, there is provided a method of determining the efficacy of a medicament for the treatment of wounds or scars, for example a medicament for preventing scarring, or improving the appearance of scars. The method comprises selecting first and second scarring site portions, wherein said first scarring site portion has been treated with said medicament. At each of a plurality of predetermined times, a pair of images comprising a first image of said first scarring site portion and a second image of said second scarring site portion is generated. Said pairs of images are consecutively displayed, the pairs of images being displayed in an order determined by times at which the pairs of images were generated. A user input element comprising first and second recording portions is provided, wherein said first recording portion comprises a plurality of first points indicating that scarring in said first image is less severe than scarring in said second image, and said second recording portion comprises a plurality of second points indicating that scarring in said second image is less severe than scarring in said first image, each of said first and second points have different associated values. User input identifying one of said points is received and comparative data based upon said user input is generated, said comparative data being used to determine the efficacy of said medicament.

The second aspect of the invention allows a plurality of pairs of images to be used so as to inform a provider of data of the nature of the original scar, and show changes in the scar through the scar maturation process. That is, although data is collected based upon a finally displayed pair of images, previously displayed pairs of images are useful in allowing a provider of data to appreciate the location of the scar, its length, and its healing process.

The term “scarring site” is used to indicate tissue (e.g. skin) in which a scar has formed or at which a scar is expected to form. As such, the term “scarring site” includes tissue including a scar, tissue including a wound which would ordinarily result in a scar, and tissue which is to be wounded such that a scar would ordinarily result from such wounding. The term “scarring site portion” is used to indicate the whole or part of a scarring site, as that term is described above. The first and second scarring site portions may be portions of a common scarring site (e.g. portions of a single scar) or alternatively may be portions of different scarring sites (e.g. each scarring site portion may be the whole or part of respective different scars)

According to a third aspect of the invention, there is provided, a method of determining the efficacy of a medicament for the treatment of wounds or scars, the method comprising selecting first and second scarring site portions wherein said first scarring site portion has been treated with said medicament, providing a recording element comprising first and second recording portions, wherein said first recording portion comprises a plurality of first points indicating that scarring in said first scarring site portion is less severe than scarring in said second scarring site portion, and said second portion comprises a plurality of second points indicating that scarring in said second scarring site portion is less severe than scarring in said first scarring site portion, each of said first and second points having different associated values, and receiving data identifying one of said points and using said data to determine the efficacy of said medicament.

According to a fourth aspect of the invention, there is provided a method of generating comparative data indicating a comparison between severity of scarring in two images. The method comprises displaying first and second images, each of said first and second images being an image of human or animal skin which includes a scar, and displaying a user input element. The user interface element comprises first and second recording portions, wherein said first recording portion comprises a plurality of first points indicating that scarring in said first image is less severe than scarring in said second image, and said second recording portion comprises a plurality of second points indicating that scarring in said second image is less severe than scarring in said first image. Each of said first and second points have different associated values. User input identifying one of said points is received, and comparative data is generated based upon said user input.

According to a fifth aspect of the invention, there is provided a computer-implemented method of generating comparative data. The method comprises displaying first and second images on a display device associated with the computer, each of said first and second images being an image of human or animal skin which includes a scar. A user input element comprising first and second recording portions is displayed on said display device, wherein said first recording portion comprises a plurality of first points indicating that scarring in said first image is less severe than scarring in said second image, and said second recording portion comprises a plurality of second points indicating that scarring in said second image is less severe than scarring in said first image, each of said first and second points having different associated values. User input identifying one of said points is received at the computer, and comparative data based upon said user input is generated.

According to a sixth aspect of the present invention, there is provided a method for collecting comparative data relating to the relative severity of scarring in first and second scar portions. The method comprises providing a recording element comprising first and second recording portions, wherein said first recording portion comprises a plurality of first points indicating that scarring in said first scarring site portion is less severe than scarring in said second scar portion, and said second recording portion comprises a plurality of second points indicating that scarring in said second scarring site portion is less severe than scarring in said first scar portion, each of said first and second points having different associated values. Data indicating one of said points is obtained to collect said comparative data.

According to a seventh aspect of the invention, there is provided a tangible medium for collecting comparative data relating to the relative severity of scarring in first and second scar portions. The medium comprises a scale comprising first and second recording portions, wherein said first recording portion comprises a plurality of first points indicating that scarring in said first scar portion is less severe than scarring in said second scar portion, and said second recording portion comprises a plurality of second points indicating that scarring in said second scar portion is less severe than scarring in said first scar portion, each of said first and second points having different associated values.

According to a eighth aspect of the invention, there is provided a method of obtaining data indicating a severity of scarring in human or animal skin in response to wounding of said human or animal skin. The method comprises displaying at least one first image of said human or animal skin, the or each first image being an image of a scar formed at a respective first time after wounding of said human or animal skin; displaying a second image of said human or animal skin, said second image being an image of a scar formed at a second time after wounding of said human or animal skin, wherein said second time is longer than the or each first time; and receiving as input data indicating the severity of scarring in said human or animal skin in response to display of said second image.

In this way, the eighth aspect of the invention allows the or each first image to be used to ‘orientate’ a provider of input data as to the original location and nature of the scar, making the input data provided in response to display of the second image more useful.

The recording element may be provided on a medium upon which the data is recorded. The recording element described above can take the form of a user input element. More specifically, the recording element may be provided as part of a graphical user interface with which a user interacts using a suitable input device such as a mouse to control the position of a pointer within the user interface. Features described in the context of a user input element can, unless required otherwise by their context, be similarly applied to a recording element which does not take the form of a user input element which is part of a user interface. Similarly, features described in the context of a recording element can, unless required otherwise by their context, be similarly applied to a user interface element.

It has been discovered that providing a recording element in the form of a scale in which a first portion comprises points indicating that scarring in a first scaring site portion is less severe than scarring in a second scaring site portion and in which a second portion comprises points indicating that scarring in the second scarring site portion is less severe than scarring in the first scarring site portion provides an effective way of generating comparative data indicating a comparison between the severity of scarring in the two scarring site portions or two images of the scarring site portions. The described methods can be used to collect data either by direct inspection of a patient's skin, or alternatively by investigation of images of a patient's skin.

Values associated with said first points may define a range of values extending from a first limit value indicating that scarring in said first scarring site portion is markedly less severe than scarring in said second scarring site portion, to a second limit value indicating that scarring in said first scarring site portion is only marginally less severe than scarring in said second scarring site portion. Values associated with said second points may define a range of values extending from a third limit value indicating that scarring in said second scarring site portion is markedly less severe than scarring in said first scarring site portion to a fourth limit value indicating that scarring in said second scarring site portion is only marginally less severe than scarring in said first scarring site portion. In this way, the recording element described above allows a user to provide data indicating which scaring site portion shows scarring of least severity, and to attach quantitative information to the provided data by indicating the degree of difference in the severity of scarring.

The first and second images of scarring are preferably displayed simultaneously. For example, the first and second images may be displayed alongside one another.

The user input element may be displayed such that said first portion of said user input element is aligned with said first image and such that said second portion of said user input element is aligned with said second image. For example, the first and second images may be displayed alongside and abutting one another in an image display portion. The user input element may extend along the image display portion such that said first portion of said user input element is aligned with said first image and such that said second portion of said user input element is aligned with said second image. An end of the first portion may be aligned with an edge of the first image and an end of the second portion may be aligned with an edge of the second image.

The user input element may further comprise a third portion comprising a third point indicating that each of said first and second images show equally severe scarring. The third point may be aligned with a line along which said first and second images abut one another. The second and fourth limit values may be associated with respective points of the user interface element which are adjacent to said third portion of said user input element. Similarly, the first and third limit values may be associated with respective points of the user interface element which are distant from said third portion of said user input element.

Each of said first and second images may be images of the skin of a common subject. The first image may include a first scar at a first predetermined time and the second image may include a second scar at the same said first predetermined time. The predetermined time may be defined with reference to a time at which a wound was created or a time at which a wound or scar was treated with a medicament.

Treatment of a scarring site with a medicament can be carried out in any convenient way, as will usually be determined by the nature of the medicament. For example, the medicament may be injected at the margins of a wound, or alternatively may be applied to the wound in the form of a cream or ointment. Alternatively, the medicament may be injected at a site at which a wound is to be created, so as to minimise the effect of and/or improve the appearance of scarring in response to intended wound creation. Such intended wound creation may be for the purposes of a surgical procedure. As a further alternative the medicament may be applied to an existing scar, either by injection or application in the form of a cream or ointment.

In some embodiments, the method may further comprise, before displaying said first and second images, displaying an ordered plurality of image pairs, a first image of each image pair being an image of said first scar, and a second image of each image pair being an image of a second scar.

Each image of an image pair may be displayed simultaneously, for example the images of an image pair may be displayed alongside one another. Each of said image pairs may comprise images of said first and second scars generated at a respective predetermined time.

Said plurality of image pairs may be ordered with reference to said respective predetermined times at which the images were generated. The, or each, predetermined time may be defined with reference to at least one of creation of a scar and treatment of a scar. The respective predetermined times are preferably shorter than said first predetermined time. That is, each image pair may comprise images generated before generation of the first and second images. The image pairs may be generated at regularly spaced apart time intervals. For example, a first image pair may be generated one month after wounding and a second image pair may be generated two months after wounding, and so on.

Each of said plurality of image pairs may be displayed for a predetermined time period. That is, a user may be presented with a series of image pairs on a display screen, the image pairs being presented at predetermined time intervals.

The user input element may comprise a line. The first portion may be a first portion of the line, and the second portion may be a second portion of said line.

After obtaining data indicating one of said first points, the method may further comprise presenting a question relating to clinical significance of said perceived difference in scarring and receiving a response to the presented question.

The methods described herein can be used to provide an endpoint assessment in a clinical trial using standardised photographs assessed by an independent clinical expert panel made up of board certified surgeons (both plastic and general) and aesthetic dermatologists. The methods are particularly applicable in defining an endpoint based upon scarring within a single patient. The methods allow for direct comparison of two scars in the same patient (for example one treated with the medicament of interest, and the other treated with a placebo). It has been found that assessment of scarring can be usefully carried out at 12-months after wound creation (e.g. 12-months after surgery).

It has been found that generating data using the methods described above minimizes the need for training and pre-screening of individuals who are to provide the user input, whilst at the same time optimizing the reproducibility and reliability and minimizing the variability of the generated data. Additionally the methods can be used to obtain data from a variety of different types of individuals including independent clinicians, patients and investigators. The methods allow the improvement in scarring caused by a particular medicament to be effectively determined.

The described methods combine comparative qualitative assessments of improvement with a quantitative scale for determining improvement, such that both statistical significance and clinical meaningfulness can be assessed from a single measure.

The methods are easily understandable by both lay and clinical people, such that the expected improvement derived from use of a medicament can be conveyed more easily in a Summary of Product Characteristics (SmPC) of the type routinely used within approval processes for pharmaceutical products, without detailed knowledge of the operation of the methodologies employed.

The described methods are also advantageous given their applicability to a range of skin types, for example a range of skin colours and skin tones. This is a considerable benefit provided by the described methods which is not achieved by some prior art methods, particularly the anchored visual analogue scale method described above.

The methods described above have been tested in four clinical trials. These clinical trails involved both very good scars (1 cm full thickness incisions made in volunteers and longer 4-7 cm patient breast augmentation incisions) and very poor scars (scar revision surgery). The data obtained, derived principally from the assessment of standardised photographs by two independent clinical expert panels made up of Board Certified plastic surgeons/facial plastic surgeons and dermatological surgeons, has been used to validate the described methods with respect to various parameters.

It has been found that the described methods provide good intra-assessor consistency. The data collected has shown that 11/12 clinicians passed consistency tests, i.e. did not score significantly differently (paired t-test; p>0.05) when shown 10% (randomly) repeated images throughout scoring sessions.

It has also been found that the methods described reduce inter-assessor variability in comparison to the previously validated visual analogue scoring method described above. The data collected confirms the potential for a significantly reduced coefficient of variation based on the largest standard deviation of the mean observed for six assessors on a clinical panel and the mean improvement needed to predict a clinically meaningful result.

It has also been found that the methods described above are not limited to the assessment of images by an independent clinical panel, but can also be used by an investigating surgeon or patient carrying out on-the-patient examination of scars

A ninth aspect of the invention provides a method of obtaining data relating to a plurality of images from a plurality of image assessors. The method comprises storing data identifying each of said plurality of images, storing data identifying each of said plurality of assessors, storing data identifying relationships between one or more sub-sets of said plurality of images and one of said plurality of assessors, receiving data identifying said one of said plurality of assessors, and causing display of one of said sub-sets of said plurality of images so as to obtain data relating to said sub-set of said plurality of images.

The ninth aspect of the invention therefore provides a convenient way in which data can be obtained. More specifically, given the defined relationships an assessor can access a central computer which stores images and be provided with the relevant images for assessment regardless of the assessor's location. Thus, the eighth aspect of the invention provides considerable benefits in terms of portability. These benefits are achieved while allowing data to be centrally obtained and stored in the database.

If the data identifies a relationship between a plurality of subsets and said one of said plurality of assessors, the method may comprise displaying data identifying the plurality of subsets and causing display of one of the subsets in response to user input.

The method may further comprise storing data defining at least one group of assessors, identifying the group of assessors based upon said data identifying said one of said plurality of assessors, and identifying one of said subsets of said plurality of images based upon said identified group of assessors. Obtaining data relating to said subset of said plurality of images may comprise generating comparative data using a method as set out above.

A tenth aspect of the invention provides a method for obtaining data indicating the severity of scarring shown in an image. The method comprises selecting an image to be displayed, receiving as input data generated by scanning a computer readable identifier (e.g. a barcode) associated with a scar cast, determining whether the selected image and the input data satisfy a predetermined relationship; and collecting data indicating the severity of scarring if said predetermined relationship is satisfied.

In this way, the tenth aspect of the invention allows an assessor to scan a computer readable identifier such as a barcode affixed to a physical scar cast so as to identify the physical scar cast. A check can then be carried out to ensure that an image selected for display matches the physical scar cast from which the computer readable identifier was read. For example a check can be carried out to ensure that the image and cast are of a common scar. The collected data may be based upon the severity of scarring shown in the selected image and in the associated scar cast. It will be appreciated that features described in connection with a particular aspect of the invention can be applied to other aspects of the invention.

It will also be appreciated that aspects of the invention can be implemented in any convenient way, including by way of suitable methods or apparatus. Some aspects of the invention are implemented by way of suitable computer programs. Such computer programs can be carried on appropriate carrier media such as tangible carrier media (e.g. CD-ROMS, Hard disk drives etc) and intangible carrier media (e.g. communications signals). The invention also provides computers programmed to carry out methods in accordance with aspects of the invention.

Embodiments of the present invention will now be described, by way of example, with reference to the accompanying drawings in which:

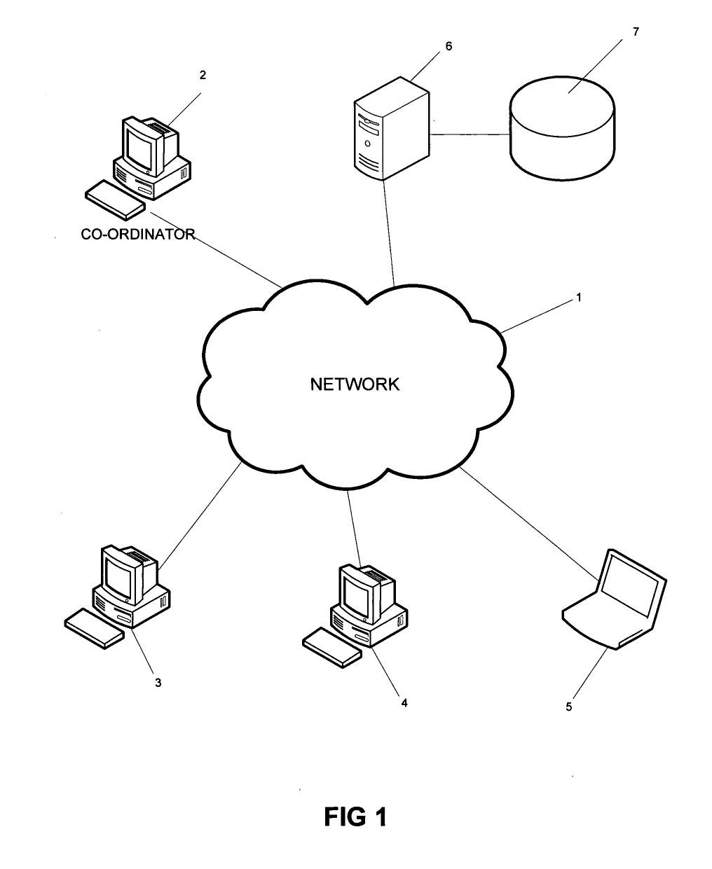

FIG. 1 is a schematic illustration of a computer network on which embodiments of the invention can be implemented;

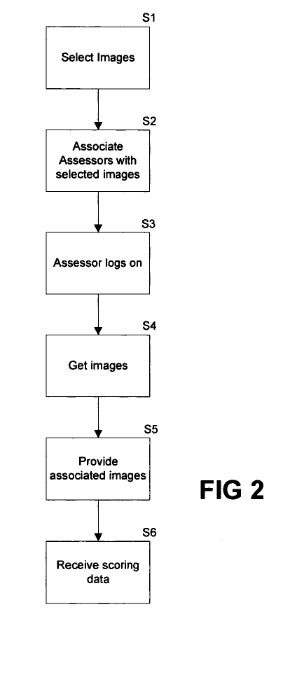

FIG. 2 is a high level flowchart of processing carried out in an embodiment of the invention;

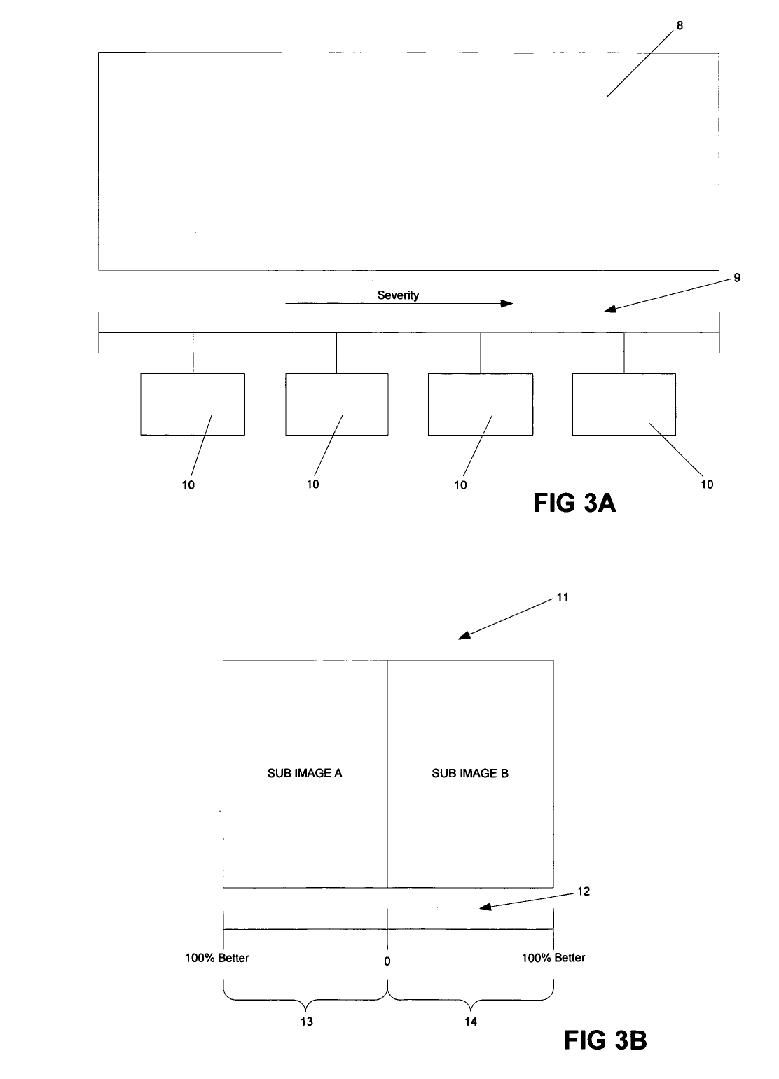

FIG. 3A is a schematic illustration of a data collection screen provided in an embodiment of the invention to obtain scoring data associated with a displayed image;

FIG. 3B is a schematic illustration of a data collection screen provided in an embodiment of the invention to obtain scoring data indicating a comparison between two sub-images of a displayed image;

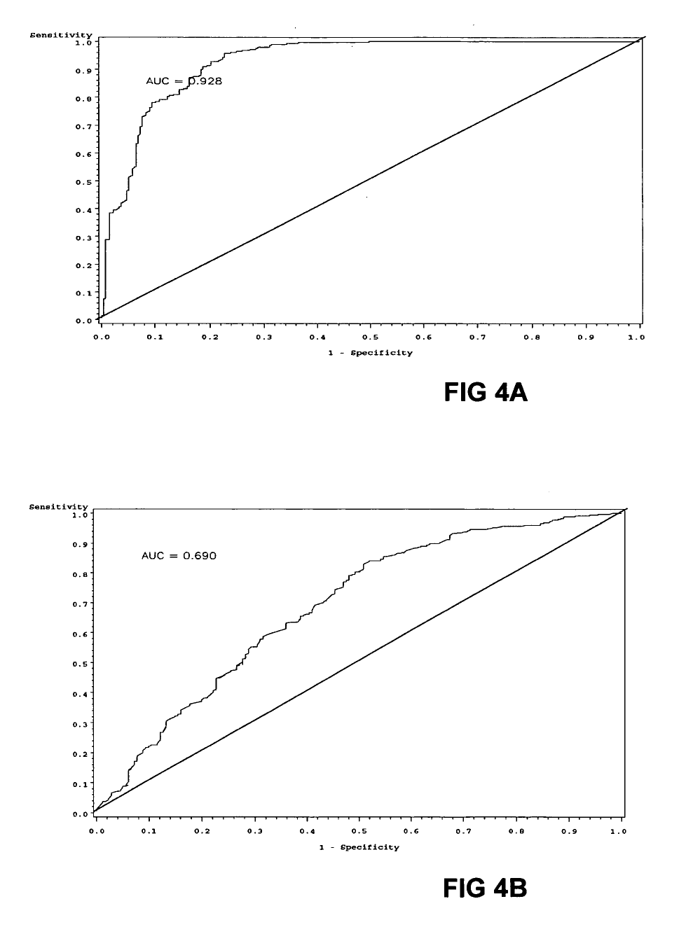

FIG. 4A is a receiver-operator characteristic curve obtained from scoring data input using the data collection screen of FIG. 3B;

FIG. 4B is a receiver-operator characteristic curve obtained from scoring data input using the data collection screen of FIG. 3A;

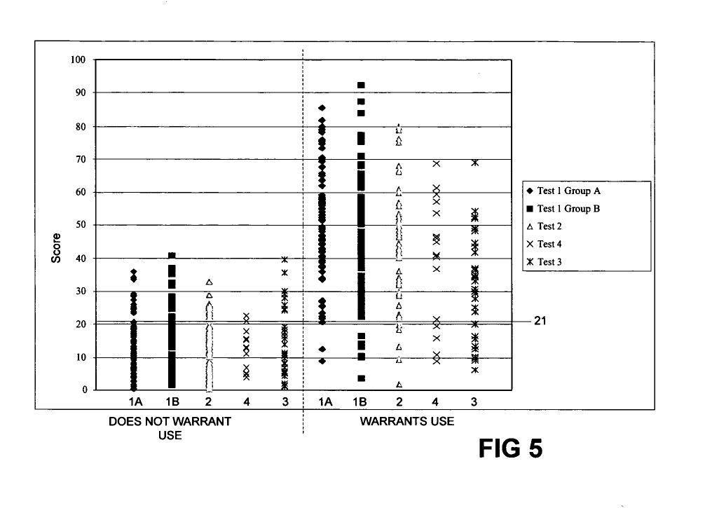

FIG. 5 is a graph showing the effects of assessor type and scar type on an applicable score cut-off to determine clinical relevance;

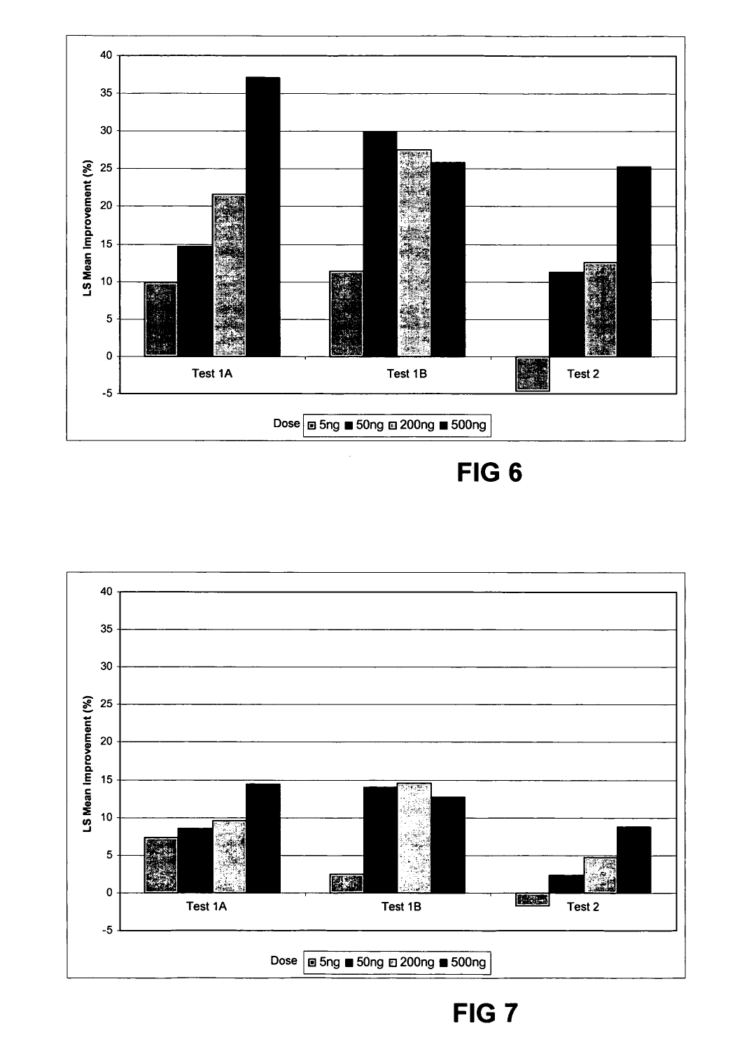

FIG. 6 is a graph showing scoring data obtained using the data collection screen of FIG. 3B;

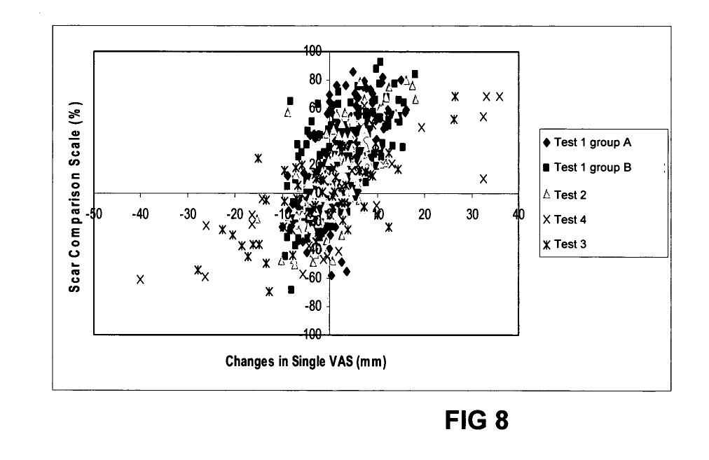

FIG. 7 is a graph showing scoring data obtained from on-the-patient inspection of scars by a surgeon;

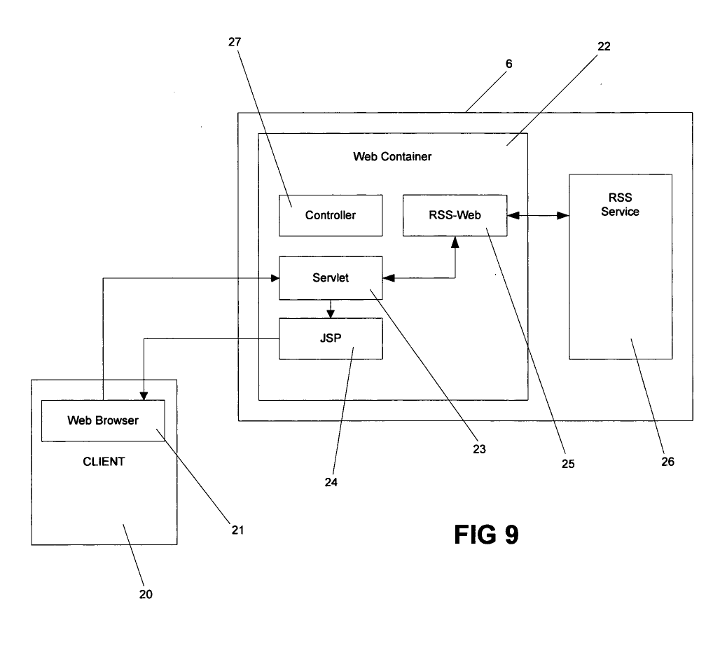

FIG. 8 is a graph showing the correlation of data obtained using the data collection screen of FIG. 3A with data obtained using the data collection screen of FIG. 3B;

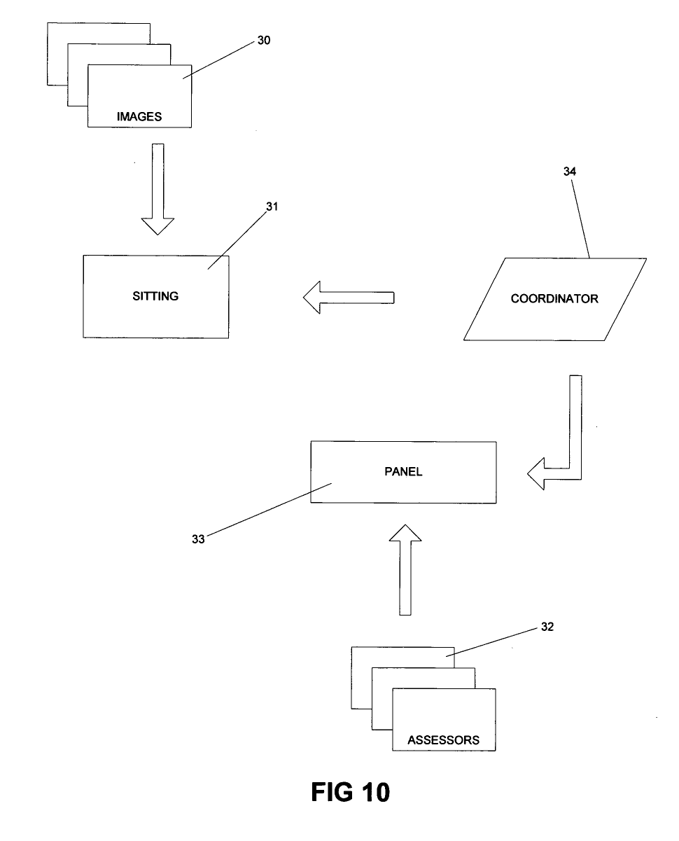

FIG. 9 is a schematic illustration of software components used to implement an embodiment of the invention using the network of FIG. 1;

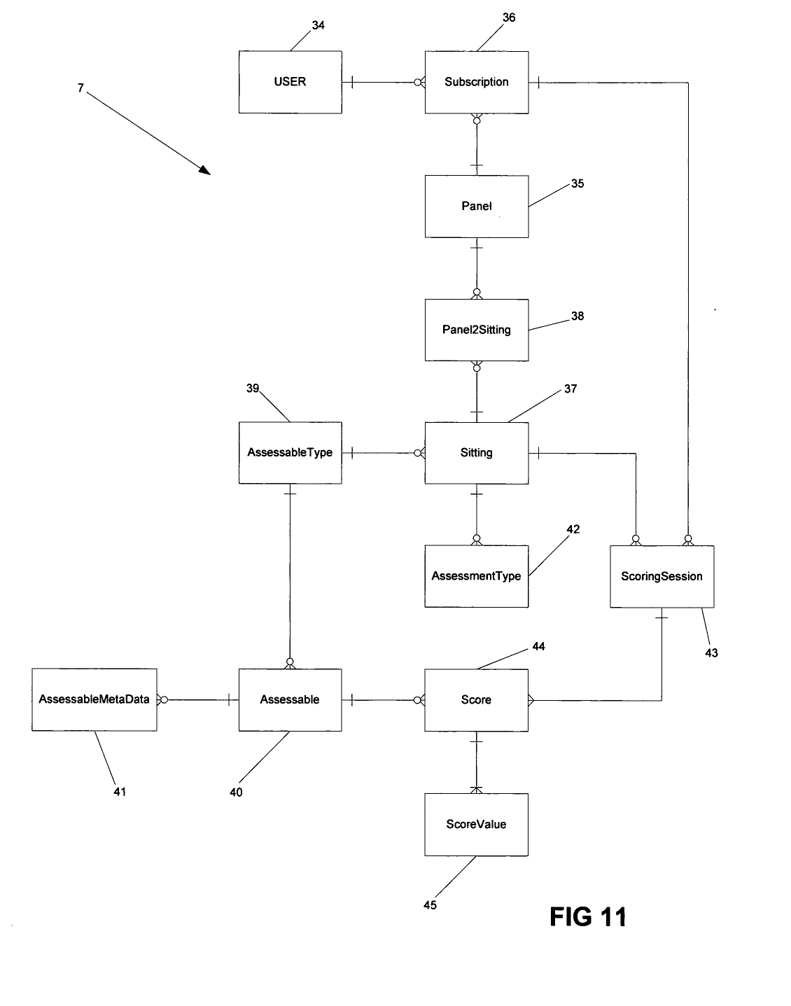

FIG. 10 is a schematic illustration showing data constructs used to implement an embodiment of the invention;

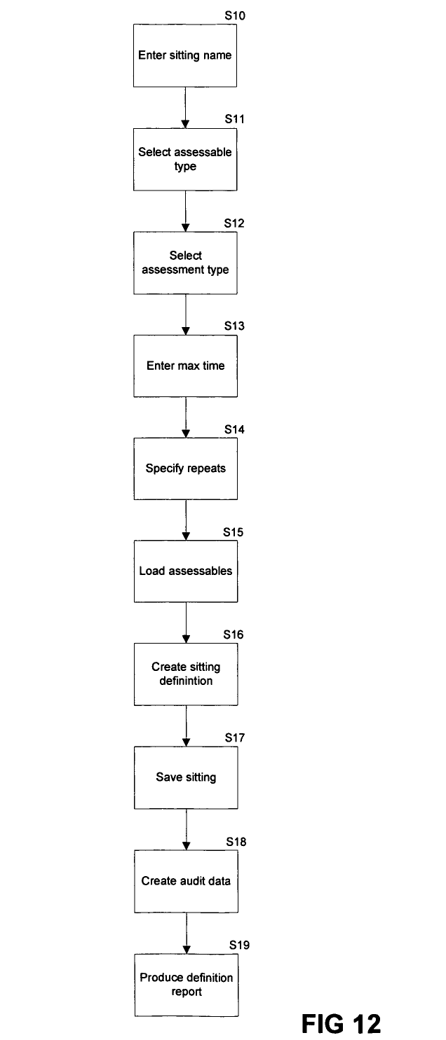

FIG. 11 is an entity relationship diagram of database tables used to implement an embodiment of the invention;

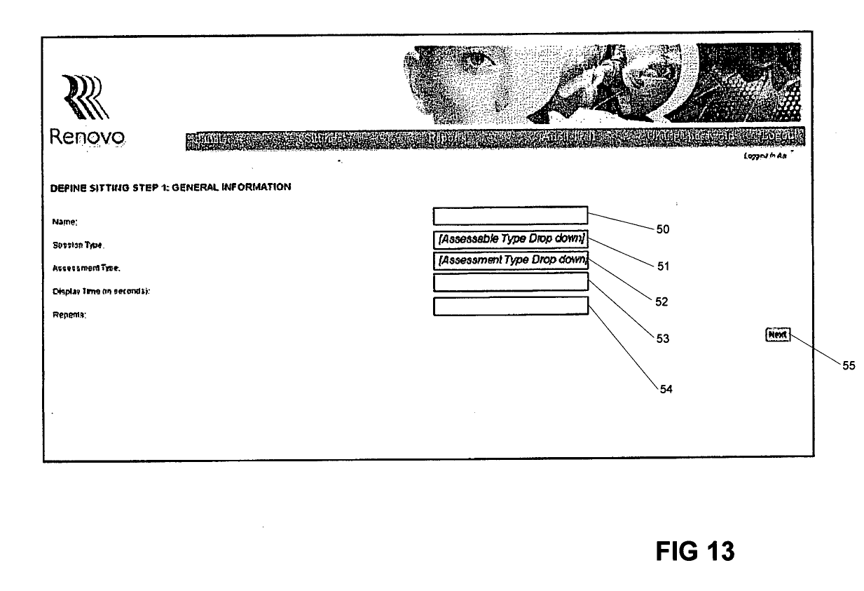

FIG. 12 is a flowchart showing processing carried out to define a sitting in which scoring data is to be collected from assessors;

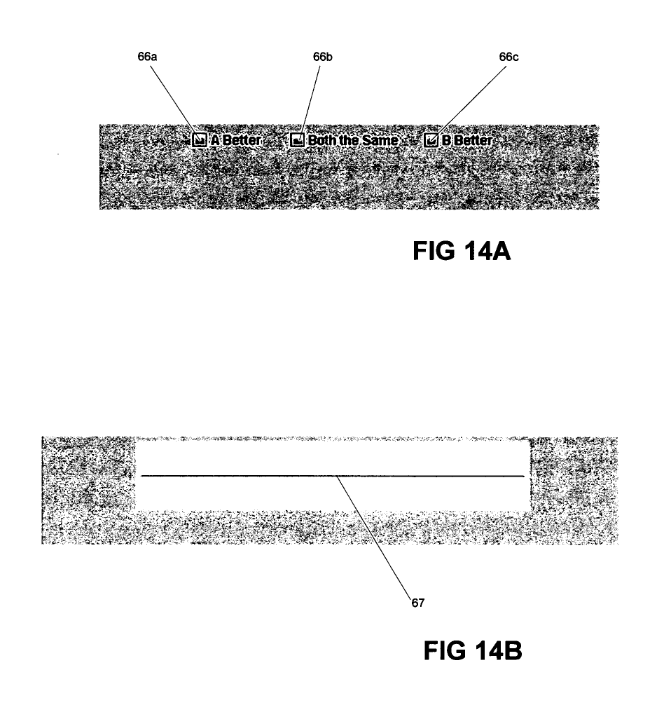

FIG. 13 is a screenshot of a webpage used in the processing shown in FIG. 12;

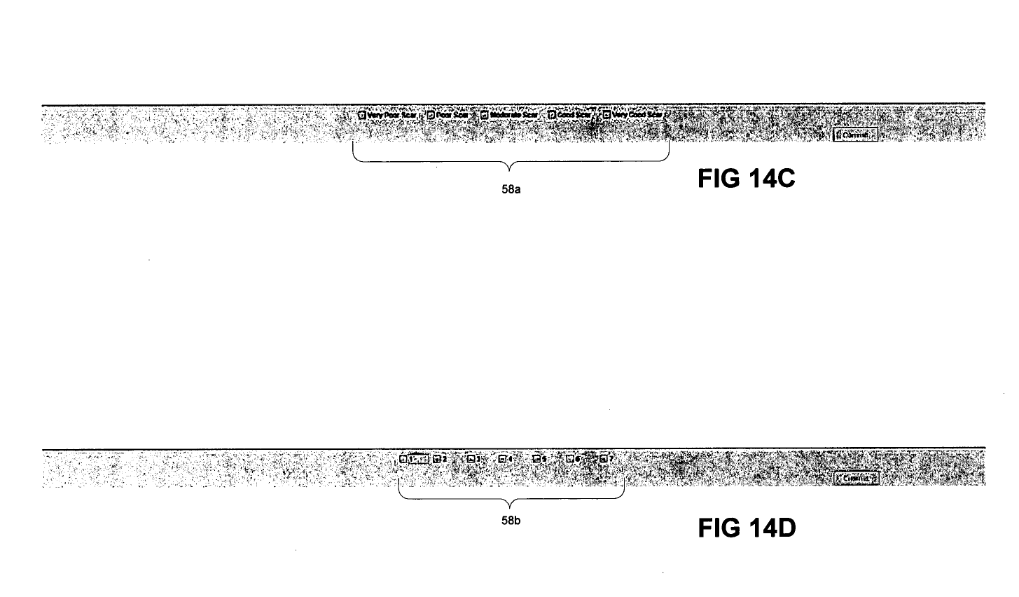

FIGS. 14A to 14E are screenshots of user interface elements arranged to allow the input of scoring data;

FIG. 14F is a screenshot of a user interface element arranged to allow the input of secondary data indicating the significance of a difference between images;

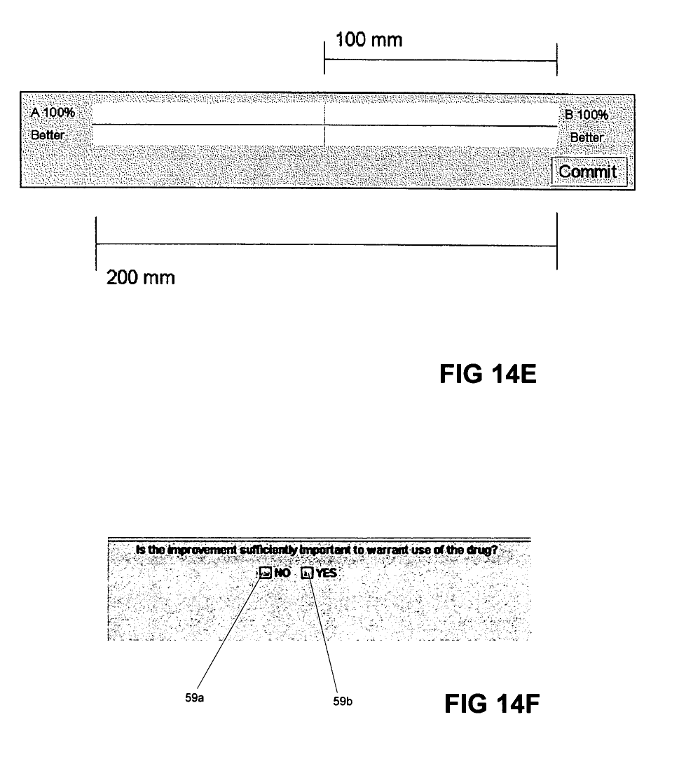

FIG. 15 is a flowchart showing processing carried out to upload images to a server in the processing of FIG. 12;

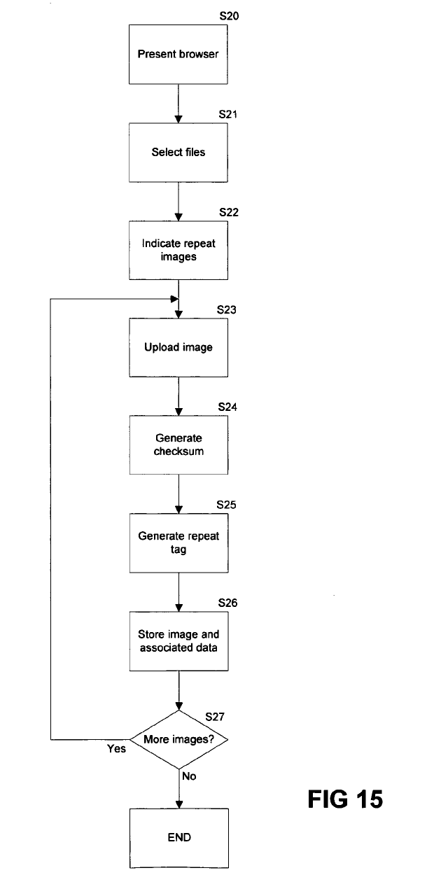

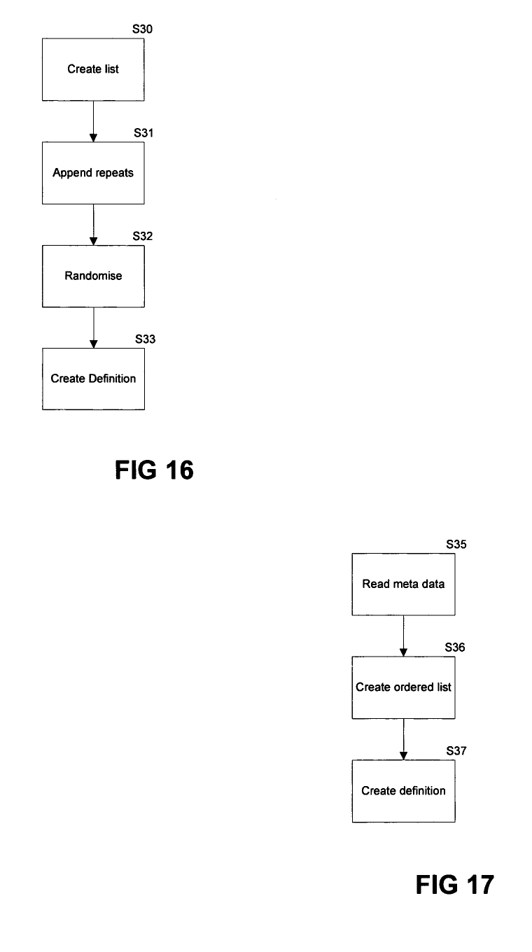

FIGS. 16 and 17 are flowcharts showing processing carried out to create a sitting definition in the processing of FIG. 12;

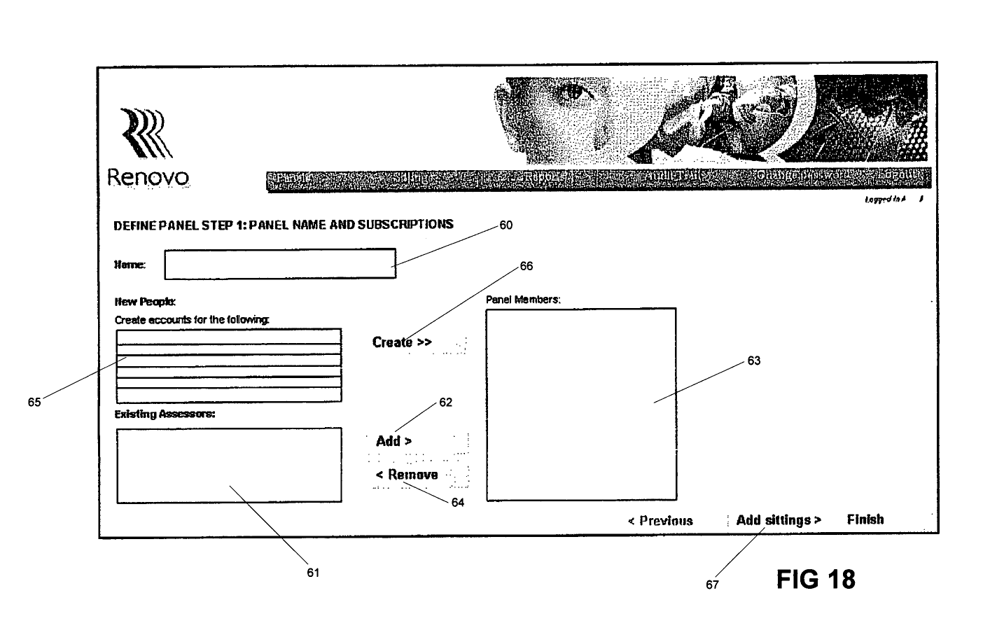

FIG. 18 is a screenshot of a webpage used to define a panel of assessors which is to provide scoring data;

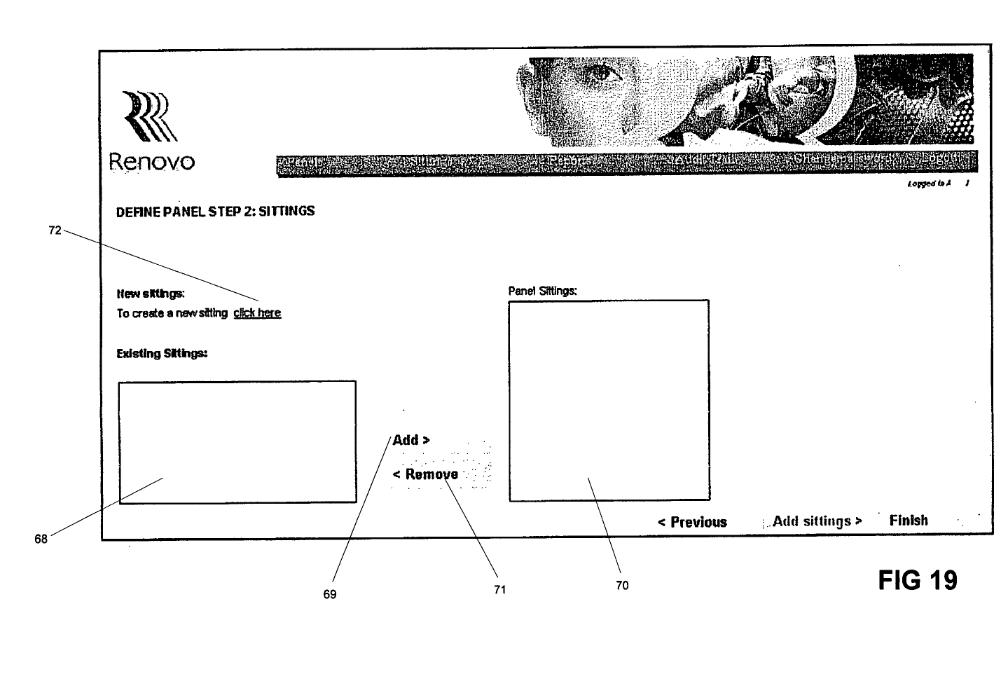

FIG. 19 is a screenshot of a webpage used to associate a panel of assessors with sittings;

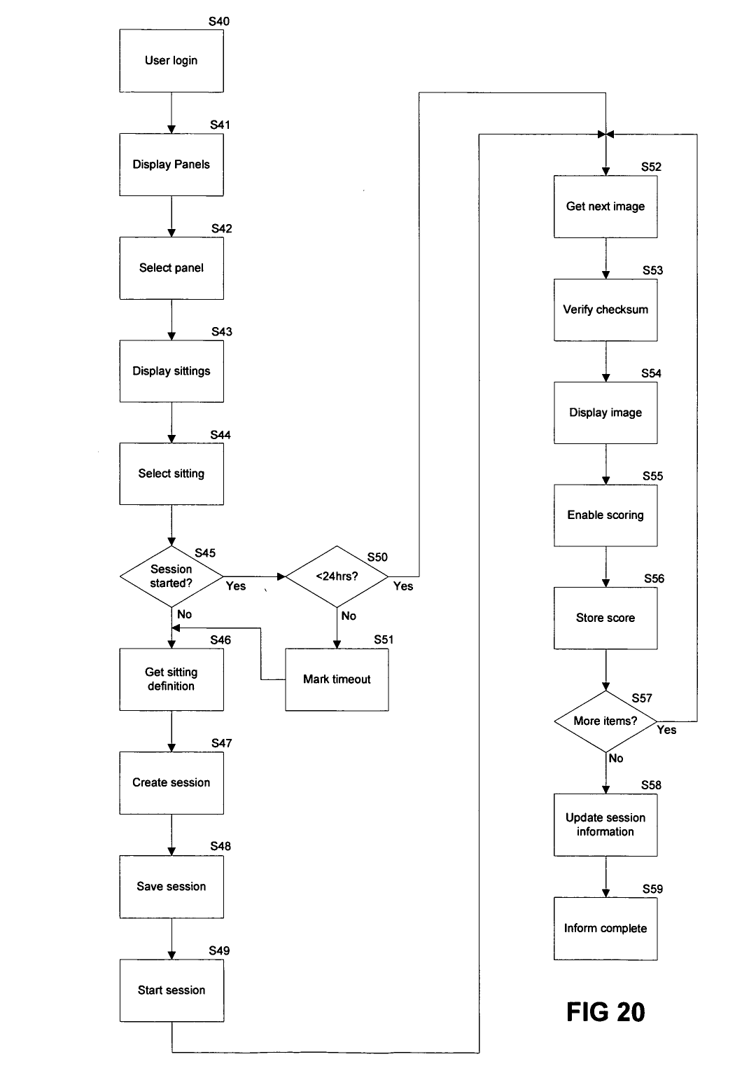

FIG. 20 is a flowchart showing processing carried out to allow an assessor to input scoring data;

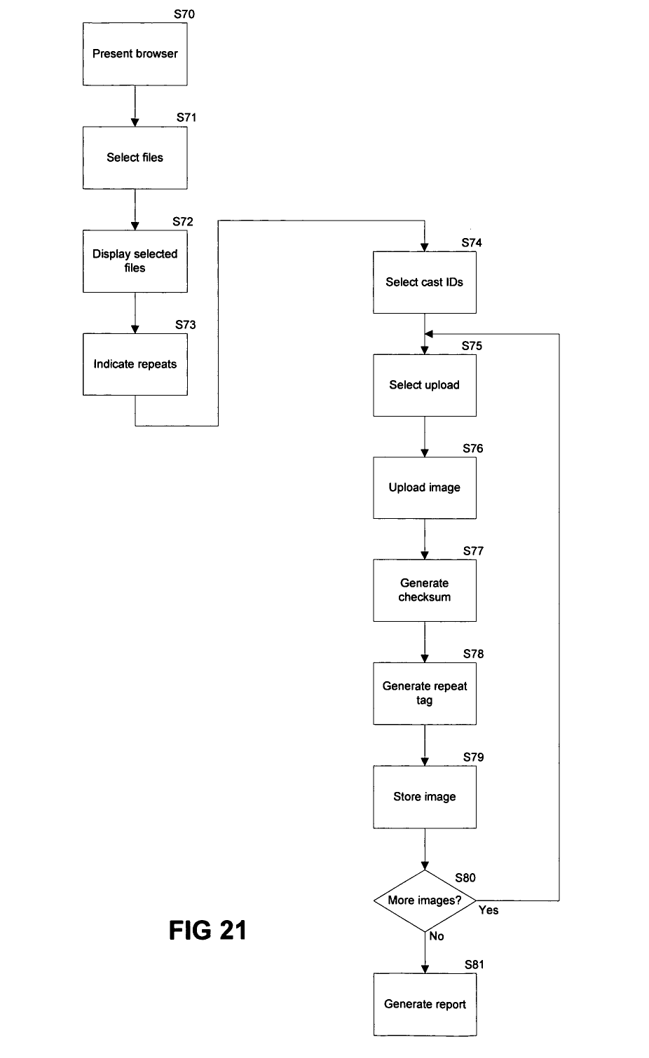

FIG. 21 is a flowchart showing processing carried out to store images in a database, where the images are associated with physical scar casts;

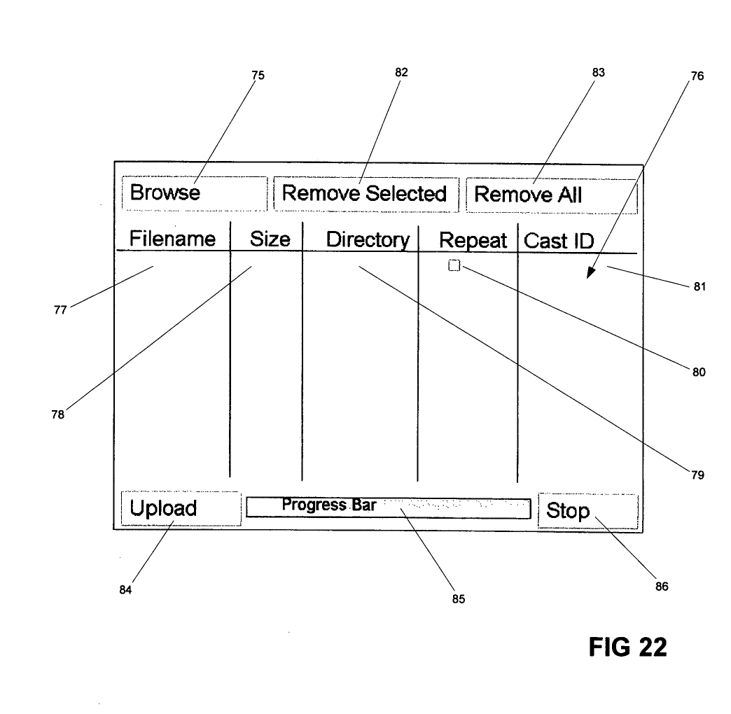

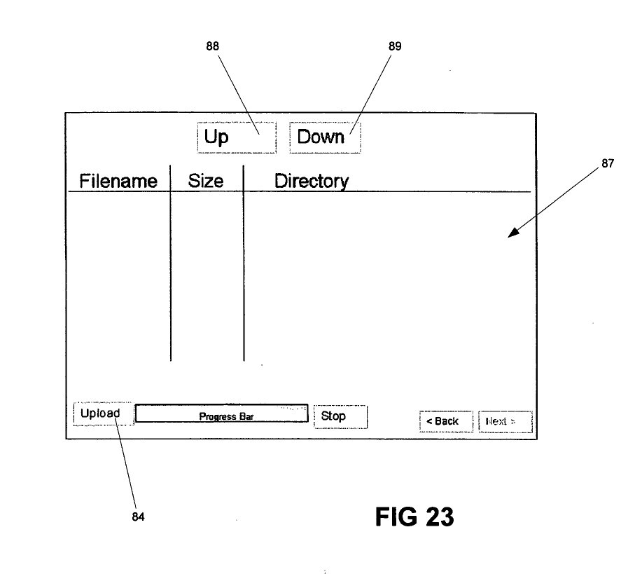

FIGS. 22 and 23 are screenshots of user interfaces used in the processing of FIG. 21;

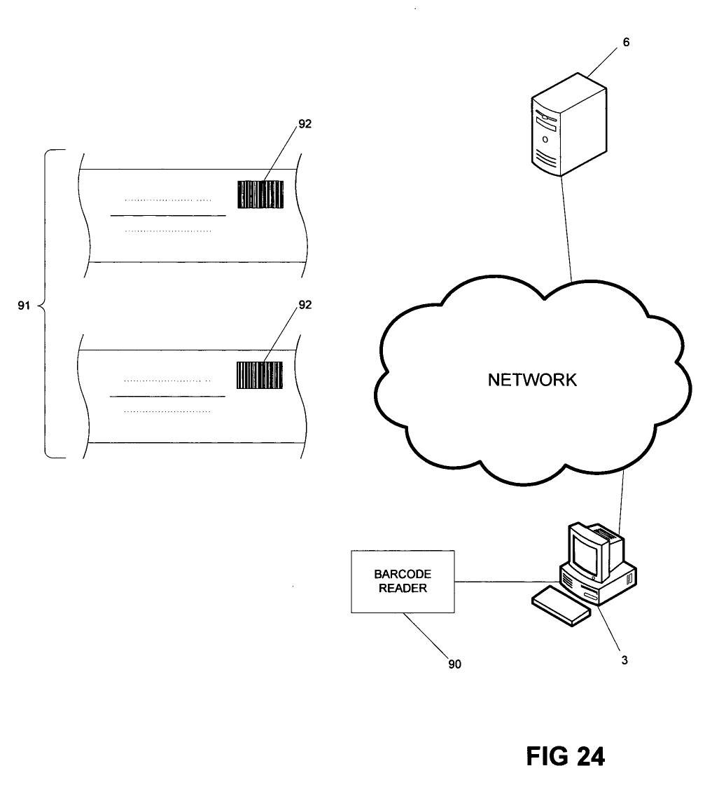

FIG. 24 is a schematic illustration of an arrangement suitable for the collection of scoring data based upon images and associated physical scar casts;

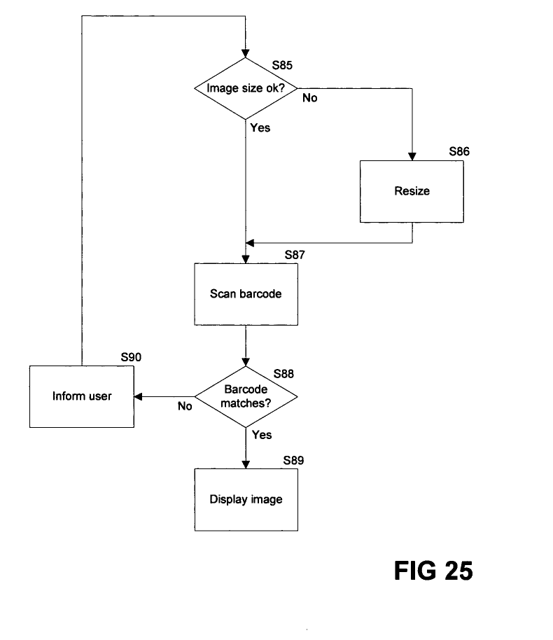

FIG. 25 is a flowchart of processing carried out to display an image associated with a particular physical scar cast;

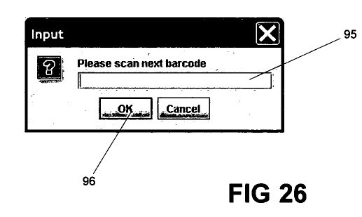

FIG. 26 is a screenshot of a dialog box used to prompt an assessor to scan a barcode identifier;

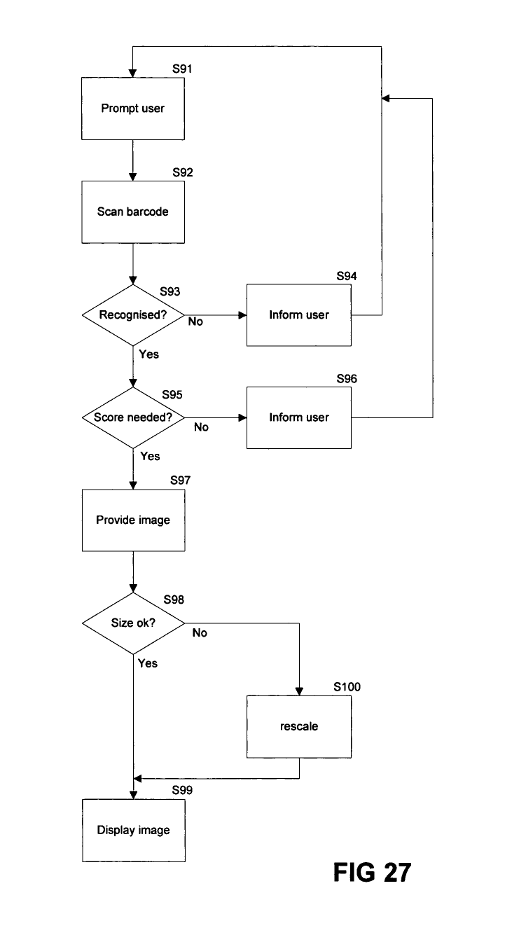

FIG. 27 is a flowchart showing alternative processing carried out to display an image associated with a particular physical scar cast; and

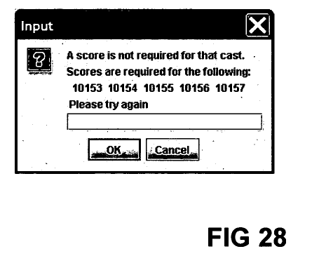

FIG. 28 is a screenshot of a dialog box used to prompt an assessor to scan a further barcode identifier.

FIG. 1 illustrates a network 1 to which a plurality of computers are connected. The network 1 can take any suitable form and can be a local area network (LAN) or a wide area network (WAN) such as the Internet. The network 1 can be a wired or wireless network, and can suitably take the form of a wireless LAN or wireless WAN. Computers connected to the network 1 include a coordinator PC 2, two user PC's 3, 4 and a user laptop 5. A server 6 is also connected to the network 1. The server 6 manages and controls access to a database 7.

Embodiments of the invention allow the coordinator PC 2 to generate data for storage in the database 7. Such data is provided from the coordinator PC 2 to the server 6 through the network 1 as described further below. The server 6 stores received data in the database 7.

The server 6 acts as a webserver. As such, the coordinator PC 2 can provide data for storage in the database 7 by accessing web pages provided by the server 6 and specifying details of the data which is to be uploaded to the database 7 using the accessed web pages, as is described in further detail below. Additionally, the user PC's 3, 4 and the user laptop 5 are able to access webpages provided by the server 6 over the network 1. Such webpages are configured so as to allow users to access data stored in the database 7, and also to allow users to input data for storage in the database 7.

The network of computers shown in FIG. 1 and described above can be used so as to allow a coordinator using the coordinator PC 2 to upload a collection of images to the database 7. The uploaded images are images of scarring of human or animal skin. Users of computers connected to the network 1 are then able to download images stored in the database 7 by accessing webpages provided by the server 6. The users can further input metadata associated with a downloaded image. Such metadata can then be stored in the database 7. Such processing can be useful in allowing users of the user PC's 3, 4 and the user laptop 5 to specify data indicating a perceived degree of severity of a scar, or data indicating a perceived comparison between the severity of a pair of scars, as described further below.

FIG. 2 shows processing carried out to obtain data related to images of scarring of the human skin. At step S1, a coordinator uses the coordinator PC 2 to select a collection of images of scarring of the human skin which are to be assessed by users, referred to as assessors. Such assessment is referred to herein as ‘scoring’. At step S2, a group of assessors who are to assess the collection of images selected at step S1 is specified, and data associating the specified assessors with the selected images is then stored in the database 7.

A user accesses the server 6 by accessing appropriate webpages using one of the user PC's 3, 4 or the user laptop 5. The assessor identifies himself or herself to the server 6 by providing appropriate logon information in the form of a user name and password at step S3. The server 6 identifies one or more images which are to be scored by an assessor at step S4. This identification is based upon stored associations between the assessor (identified by the provided user name and password) and one or more collections of images stored in the database 7.

Having identified one or more images which are to be scored, the images are provided from the server 6 to the assessor's computer over the network 1 at step S5. Images received at the assessor's computer are displayed on an appropriate display screen, and the assessor is then able to enter scoring data which is to be associated with the displayed image. Such scoring data is provided from the user's computer to the server 6, and is received by the server 6 at step S6 for storage in the database 7.

As described further below, scoring data can be input in a variety of ways. FIG. 3A shows one way of obtaining scoring data which is associated with an image 8 representing a scar. A scale 9 is displayed, and the assessor marks a point on the scale 9 to indicate a perceived severity of the scar. If the scar is relatively severe, a point to the right hand side of the scale 9 will be selected. If the scar is less severe a point further to the left hand side of the scale 9 is selected.

Asking an assessor to indicate a perceived severity of scarring in a particular scar without providing further guidance, is unlikely to produce robust scoring data. As such, it can be seen that a plurality of images 10 are associated with points along the scale 9. These images are control images and can be used by an assessor to determine a point on the scale 9 which best indicates the severity of scarring shown in the image 8. That is, the severity of scarring shown in the image 8 can be compared with the severity of scarring shown in each of the images 10 so as to determine the point on the scale 9 which should be indicated by an assessor.

In order to allow scoring data to be effectively obtained using the technique described with reference to FIG. 3A, it is necessary to store a plurality of sets of control images 10 so as to have control images which are relevant to the skin tone of a particular image 8. That is, if the image 8 is an image of scarring in Caucasian skin, the control images 10 should similarly be images of scarring in Caucasian skin if the control images 10 are to provide proper guidance to an assessor. Similarly, if the image 8 is an image of scarring in skin of a particular colour, the control images 10 should similarly be images of scarring in skin of that particular colour if the control images 10 are to provide proper guidance to an assessor.

FIG. 3B shows another way of inputting scoring data. Here, the input scoring data represents a comparison between two sub-images, so as to allow the input of scoring data indicating the comparative severity of scarring.

Referring to FIG. 3B, an image 11 is displayed comprising a first sub-image A and a second sub-image B. A scale 12 is also displayed. It can be seen that the scale 12 has ‘0’ marked at its centre, and ‘100% better’ marked at each of its ends. The scale 12 can therefore be effectively used to allow an assessor to quantitatively indicate which of sub-images A and B is “better”, that is, which of the sub-images A and B shows the least severe scarring.

An assessor inputs data by marking a point on a first portion 13 of the scale if the sub-image A represents less severe scarring than the sub-image B. Similarly, the assessor inputs data by marking a point in a second portion 14 of the scale 12 if the scarring in sub-image B is less severe than the scarring in sub-image A. From FIG. 3B, it can be appreciated that if the scarring in sub-image A is considerably less severe than that in sub-image B a point relatively far to the left hand side of the scale 12 would be chosen, while if the sub-image is only marginally better than that of sub-image B, a point closer to the centre of the scale 12 would be selected. Indeed, if the scarring of sub-images A and B is perceived to be of equal severity (i.e. there is no perceptible difference in the severity of scarring) the centre point indicated ‘0’ would be selected.

For example, if the scarring in sub-image A is considered to be 50% better than the scarring in sub-image B, then a single point half way between 0 and 100% in the first portion 13 is specified. Conversely if the scarring in sub-image B is, for example, considered to be 50% better than the scarring in sub-image A then a single point is specified in the second portion 14, half way between 0 and 100%.

One example of use of the user interface of FIG. 3B is now described.

The sub-images A, B are both photographs of respective scars taken from a common patient. One of the sub-images is of a scar treated with a medicament of interest, while the other sub-image is of an untreated scar, or a scar treated with a placebo (i.e. a scar treated with a substance having no therapeutic effect). Both scars arise from wounds created, at the same time, and the sub-images A, B were similarly taken at a common time after wound creation or alternatively a common time after some treatment of each of the scars. In this way, the effectiveness of the medicament of interest in reducing scar severity can be effectively addressed using the user interface of FIG. 3B to obtain scoring data indicating the severity of scarring.

An assessor is first shown a series of pairs of sub-images. The sub-images of a particular pair are photographs of the respective scars taken at a common time after creation of the respective wounds. A plurality of pairs of sub-images are displayed in a sequential fashion. That is, the sub-images of a first pair may be photographs taken 6-weeks after wounding, while a final pair of images may comprise photographs taken 9-months after wounding. These pairs of images show the process of scar maturation. Scoring data is not collected based upon these pairs of sub-images. Instead, these pairs of images are used to orientate assessors with respect to the original wound length and body position. These pairs of images can be used as guide to where the scars are positioned in the sub-images making up the image 11 upon which scoring data is to be based. The sub-images making up the image 11 may be photographs taken 12 months after wound creation, and it is these sub-images which are used as a basis for the collection of scoring data.

The display of a plurality of pairs of images to allow the scar maturation process to be properly appreciated has been found to be helpful in allowing an assessor to better understand the nature of the original wound, and to see changes in the scar through its maturation process. Such a process has been used in tests where the assessors are medical practitioners. Such tests have shown that the method described is particularly useful if, for example, one of the two scars becomes wholly or partly imperceptible over time, if the original wound (and resultant scar) was placed near to or within a body contour/fold (e.g. an intra-mammary fold) or if clothing (e.g. underwear) has left additional marks on the skin in the photograph taken at Month 12 which could be confused with the scar. The display of the plurality of pairs of images also partly replicates the situation “in life” when a treating surgeon and/or the patient observes a scar at different times as it matures.

Since each scar pair effectively acts as its own control (i.e. direct comparison of one against the other), there is no need using this methodology to provide standardised photographs of scar severities for use as a reference in the scoring process. Indeed, the scale can be considered self-anchoring, since the only reference point needed is the centre point indicated ‘0’ (i.e. no difference). Due to the lack of reference images the scoring method behaves independently of the background skin colour and will therefore be a valid means of assessments for both Caucasian and coloured skins.

Similarly, there is no requirement to pre-screen assessors for their ability to precisely use the scale with regard to particular anchor points defined using reference images, since the improvement measure is a subjective “global impression”. The only methodological assessment of the assessors is to assure that the assessors are behaving in a consistent manner throughout the entire study. Data obtained from assessors found to be scoring inconsistently prior to unblinding the study should be excluded from the collected data prior to analysis.

Validation of the scoring method described above with reference to FIG. 3B has been undertaken by means of evaluating: intra-assessor consistency, what is a clinically meaningful improvement on the scale using two independent clinical expert panels, inter-assessor variability by means of the overall effect size, further validation of the panel by comparing the results using other assessors; and correlation of results obtained using the described method with the results of other scoring methods using the same assessors. Such validation is now described. In particular, comparison of data obtained using the interface of FIG. 3B with that obtained using the interface of FIG. 3A is described.

Validation data has been derived from the assessment of four independent Phase II clinical trials of a particular medicament. The scoring data was provided by two separate independent clinical expert panels as shown in Table 1:

TABLE 1

| Clinical | | | Number of |
|---|---|---|---|
| Trial | | Panel numbers/ | Scar Pairs |
| Ref: | Type of Scar/Population | made up of: | Scored |
| 1 | Volunteer population; 4 × | Panel 1: 6 × Facial | 312 |
| | 1 cm full thickness incisions | Plastic & | |
| | on the upper arm | Dermatological | |
| | | Surgeons | |
| 2 | Volunteer population; 4 × | Panel 1: 6 × Facial | 156 |
| | 1 cm full thickness incisions | Plastic & | |
| | on the upper arm | Dermatological | |
| | | surgeons | |
| 3 | Female Breast Augmentation | Panel 2: 6 × General | 63 |
| | Surgery; Considered good | Plastic Surgeons | |
| | patient scars | | |
| 4 | Male & Female Scar | Panel 2: 6 × General | 30 |
| | Revision Surgery; Poor and | Plastic Surgeons | |
| | disfiguring scars | | |

Following constitution, each independent clinical expert panel had two clinical trials to score, as set out in Table 1. Intra-assessor consistency was assessed by introducing, at random, 10% repeated pairs of sub-images throughout the course of a scoring session. Specifically, a paired t-test was used to determine whether each individual assessor scored repeated pairs of images significantly differently.

In summary, only one of the twelve clinical assessors involved in the two panels showed a p-value <0.05. The single assessor who did not meet the consistency standard only failed consistency in one of the three sessions he scored.

As with any methodology for assessment of scarring, it is important to determine the criteria for assessing whether any improvement in scarring can be considered to be a clinically meaningful improvement. In order to make this determination, and as part of the validation exercise, each of the clinicians on the two scoring panels were first shown pairs of sub-images as described above, and scoring data was obtained using the described methods. Immediately following scoring of each pair of sub-images a supplementary question was posed: “Is the difference in scar appearance sufficient to warrant use of the drug?”. It will be appreciated that other similar questions could be posed, for example questions directed to clinical relevance, significance or meaningfulness of an improvement caused by the drug.

The mode (i.e. most frequently occurring) response to the presented question from a group of assessors was used to determine whether the improvement for any particular scar pair represented a clinically meaningful improvement.

Receiver Operator Characteristic (ROC) analysis has been used as a statistical model to determine whether the scoring method described above with reference to FIG. 3B is a good predictor of clinical meaningfulness, using data from all 4 clinical trials, and using responses to the question relating to whether or not use of the drug was warranted.

The first step of the ROC analysis was to make a two by two table showing the diagnostic accuracy of a method at a given cut-off value. If the cut-off value is set to X, the table would be as follows:

TABLE 2

| | Clinically | Improvement |
|---|---|---|
| | Relevant | not Clinically |
| Score cut-off = X | Improvement | Relevant |
| Score <= X (i.e. predict clinically | P | Q |
| relevant Improvement) | | |
| Score > X (i.e. predict No clinically | R | S |
| relevant Improvement) | | |

From Table 2 it can be seen that relatively low scores indicate a greater improvement than relatively high scores.

In this case, the letters P, Q, R and S represent counts of the number of scar pairs in each of the four possible categories. A ROC analysis is achieved by plotting the sensitivity of the analysis against (1—specificity).

Sensitivity is defined as:

Sensitivity=P/(P+R);

and specificity is defined as:

Specificity=S/(Q+S)

Thus, sensitivity indicates the ratio of the number of pairs of sub-images which are correctly identified as indicating a clinically relevant improvement using the score cut-off X to the total number of pairs of sub-images which show a clinically relevant improvement based upon the answer to the question set out above.

Specificity is defined as the ratio of the number of pairs of sub-images which are correctly identified as not indicating a clinically relevant improvement using the score cut-off X to the total number of pairs of sub-images which do not show a clinically relevant improvement based upon the answer to the question set out above.

A common method for analysis of an ROC curve involves computation of the area under the curve (AUC). A 45° line represents the area of a chance predictor and this line has an AUC of 0.5. The area of the predictor score which could perfectly predict all clinically relevant improvements and all clinically irrelevant improvements is 1, given that both sensitivity and (1-specificity) values will be 1.

An ROC curve for data obtained using the scoring method described above with reference to FIG. 3B is shown in FIG. 4A. This shows that that area under the curve (AUC) is 0.93 making the described scoring method an excellent predictor of clinically relevant improvements.

In contrast, and for the purposes of comparison, FIG. 4B shows an ROC curve for data obtained using a scoring method in which a scar is scored based upon a visual analogue scoring method using reference images as described with reference to FIG. 3A. In this case the area under the curve is 0.69.

From the preceding discussion it can be seen that the ROC curve for data obtained using the scoring method described with reference to FIG. 3B shows that this scoring method, with an appropriate value for the score cut-off X, provides a better predicative model of a clinically relevant effect than the scoring method described above with reference to FIG. 3A.

ROC analysis can be used to determine a value for the score cut-off X which provides optimised values for sensitivity and specificity. In the present case, it has been found that setting the value of X to a 21% improvement when scoring data is obtained using the method described with reference to FIG. 3B results in specificity value of 0.88 and a sensitivity value of 0.80 which has been found to be effective.

The score cut-off to be applied to data obtained using the methods described with reference to FIG. 3B could be affected by various factors, including the nature of the assessors and the severity of the scars being assessed. Tests have therefore been carried out to determine the influence of the background (e.g. medical specialty) of members of the clinical panel (i.e. facial plastic surgeon/dermatological surgeon versus general plastic surgeon) on the score cut-off, and the influence that the severity of scars (i.e. good, fine line scar versus disfiguring hypertrophic scars) has on the score cut-off.

Data from these tests is shown in FIG. 5. A first left-hand part of the graph of FIG. 5 shows scores obtained in cases where it was determined that use of the medicament was not warranted. A second right hand part of the graph of FIG. 5 shows scores obtained in cases where it was determined that use of the medicament was warranted.

In the case of one clinical trial, scores were obtained from two groups of assessors having different specialities. This data is indicated 1A and 1B in the graph of FIG. 5. It can be seen that the nature of the assessor has no significant effect on the effectiveness of selecting a cut off score of 21%. Thus, FIG. 5 shows that irrespective of the clinical panel speciality or the scar severity, the range of improvements which are, and are not, considered clinically meaningful by the panels remain generally consistent across clinical trials, indicative of the fact that a mean 21% improvement can be used as a threshold value for determining a clinically meaningful improvement in studies using the scoring methods described above with reference to FIG. 3B.

Similarly, while the data represents a variety of scar severities, it can be seen that the effectiveness of a cut-off of 21% is maintained between trials. Indeed, if more severe scarring such as that seen in trial Test 4 (scar revision) is taken in isolation, the chances of obtaining a false positive result (i.e. the chance of determining that there is a clinically relevant improvement when in fact there is not) appear to be somewhat reduced compared to other trials where scars are generally good.

Unlike some scoring methods, the method described above with reference to FIG. 3B does not require standardised anchor images placed along the length of the line, and simply uses the comparator scar as a baseline for assessing improvements. Whilst being more subjective, this scale can be considered a much better “global impression” scale, since the clinicians are being asked to assess the improvement of the better scar in relation to its comparator in a single operation.

As a result, at the outset of validation it was expected that the inter-assessor variability (i.e. the standard deviation of the mean) would be somewhat larger with the described scoring method than that previously obtained for the scoring methods in which clinicians are trained and selected for their ability to score against the defined anchor points (e.g. as described with reference to FIG. 3A).

To assess the inter-assessor variability using the scoring method described above, the coefficient of variation (standard deviation/mean×100%) has been calculated for the threshold value needed to demonstrate clinical significance (21%), using the largest standard deviation for scores observed by the clinical panel at Month 12 across 4 clinical trials.

For the purposes of comparison, the coefficient of variation has also been determined for the scoring method known as anchored visual analogue scoring (described with reference to FIG. 3A) using a 7 mm threshold value for clinically meaningful threshold, which was calculated using ROC analysis (80% confidence) on the same data set used to derive the 21% score cut-off for the scoring method described above.

The results of this analysis are shown below in Table 3:

TABLE 3

| | FIG. 3B | FIG. 3A |
|---|---|---|
| Mean improvement to be determined clinically | 21% | 7 mm |
| relevant | | |
| Largest Standard Deviation achieved with the | 37.67% | 18.26 mm |
| Clinical Panel | | |
| Coefficient of Variation | 179% | 260% |

In summary, Table 3 shows that despite the lack of training of the independent clinical panel and the lack of guiding anchors on the scale, the single paired assessment using the method described above significantly reduces the coefficient of variation by the assessors when compared to the anchored visual analogue scoring, which requires multiple independent assessments.

In addition to the assessment of scar improvement with the independent clinical expert panel using the scoring method described above at 12 months, some trials have also used the scale 12 shown in FIG. 3B to collect data based upon an on-the-patient assessment by the Investigating Surgeon at 12 months following surgery.

FIG. 6 is a graph showing scoring data obtained from a plurality of assessors using scoring techniques as described above and the interface of FIG. 3B. Data is shown for three clinical trials, and for each trial data is shown for various dosages of the medicament of interest. FIG. 7 is a graph showing similar data obtained from surgeons performing on-the-patient analysis of scars. Although the magnitude of the improvements indicated by on-the-patient assessment appear to be smaller than that obtained from analysis of images by a plurality of assessors, it is important to note that the shape of both dose response curves are almost identical, indicative of the fact that the scoring method is behaving in a similar manner for both analysis of images by a plurality of assessors, and on-the-patient assessment by a single surgeon.

It can be seen that the mean response observed in on-the-patient analysis is smaller than that obtained by obtaining scoring data based upon the display of images to a plurality of assessors. Therefore, while a score indicating a 21% improvement was an appropriate score cut-off where scoring data is generated by a plurality of assessors, a different score cut-off should be applied to on-the-patient data. Such a score cut-off can be determined using ROC analysis as described above.

Tests have been carried out to determine correlations between data obtained using a scoring method involving input of the type described with reference to FIG. 3B and as described above, and data obtained using a scoring based upon an anchored VAS scale as described above with reference to FIG. 3A. The correlation of data is shown in FIG. 8.

Analysis of combined data from four clinical trials has indicated a correlation coefficient of 0.63, indicative of a positive correlation between the two scoring methods. Although not a strong correlation, this data nevertheless indicates that the two scales trend in the same direction. A more strongly positive correlation between the two scoring methods was not to be expected, since the area under the curves for the ROC analyses (FIGS. 4A and 4B) showed that the two scoring methods are behaving in similar but not wholly comparable ways. In part it is likely that this is due to the fact that the entire length of the scale 12 of FIG. 3B can be used to determine a scar improvement, whilst only a small part of the anchored visual analogue scoring scale of FIG. 3A tends to be used for any single study. In addition, the direction can often be distorted due to small changes in the anchored visual analogue scoring as a result of measurement error.

Having described methods for the input of scoring data, and having also described the effectiveness of such methods, the implementation of a system for the collection of such scoring data is now described. FIG. 9 shows components used to implement the system.

The server 6 runs software providing a plurality of components to allow communication with a client 20. The client 20 can be any computer connected to the network 1 (FIG. 1) and can be one of the user PC's 3, 4 or the user laptop 5, or the coordinator PC 2. The client 20 runs a web browser 21 of conventional form (such as, for example, Microsoft® Internet Explorer). The web browser 21 is configured to request and receive webpages from the server 6.

The server 6 provides a plurality of components within a web container 22 which allow communication with the client 20. These components include a servlet 23 which is configured to receive and process requests sent by the web browser 21. More particularly, the servlet 23 is configured to process a request by reference to the specified URL and to generate one or more java server pages (JSPs) 24 which are provided to the web browser 21 as a response to the request. In order to generate the JSPs 24, the servlet communicates with an RSS-web component 25 which communicates with an RSS-service 26. The RSS-service 26 is configured to receive and process data obtained via the web browser 21, store such data in the database 7 (FIG. 1), obtain data from the database 7 in response to requests made via the web browser 21, and provide the obtained data to the servlet 23 for inclusion in the generated JSPs 24. Operation of the web container is overseen by a controller component 27.

From the description of FIG. 9 it can be seen that the server 6 is configured to receive and process requests made via the web browser 21 and to provide appropriate responses to such requests. Interaction between the server 6 and the web browser 21 involves the exchange of web pages between the web browser 21 and the server 6.

Data constructs used to implement the system for obtaining scoring data are now described with reference to FIG. 10. A plurality of images 30 together form a sitting 31. The sitting 31 further comprises data indicating how the images 30 should be displayed to an assessor so as to allow scoring data to be obtained, as described in further detail below.

A plurality of assessors 32 together make up a panel 33. A many-to-many relationship exists between panels and sittings, such that each panel may be associated with a plurality of sittings, and each sitting may be associated with a plurality of panels. A coordinator 34 using the coordinator PC 2 defines relationships between sittings and panels. Relationships between sittings and panels indicate one or more panels which is to provide scoring data in connection with a particular group of images making up a sitting.

FIG. 11 is an entity relationship diagram showing database tables which store data in the described system, together with relationships there between. The tables are tables of a relational database in which relationships between tables are used to represent relationships between the entities. A User table 34 is used to store data identifying users of the system. Users comprise both assessors who provide scoring data and coordinators who configure the system to allow the collection of scoring data. The User table 34 includes a plurality of fields storing data relating to users including username and password fields, as well as data indicating a user's role (e.g. coordinator or assessor) within the system.

A Panel table 35 stores data identifying a panel that is a group of assessors who are to provide scoring data. The Panel table 35 comprises an ID field which acts as the table's primary key as well as a name field providing a textual name for the table and a field indicating whether a particular panel is active in the sense that the group of assessors are currently being used to provide scoring data.

A Subscription table 36 defines relationships between entries of the User table 34 and the Panel table 35. That is, the Subscription table 36 stores data indicating which users are members of a particular panel. It can be seen that each entry of the subscription table links a single record of the User table 34 to a single record of the Panel table 35. It can further be seen that each record of the User table 34 can be referenced by many records of the Subscription table 36, and that similarly each record of the Panel table 35 can be referenced by many records of the Subscription table 36. Each record of the Subscription table 36 therefore represents a one-to-one relationship between a user and a panel.

A sitting table 37 stores data defining a sitting, that is data defining properties associated with a plurality of images which are to be used as a basis for the collection of scoring data. A Panel2Sitting table 38 defines relationships between entries of the Panel table 35 and the Sitting table 37. It can be seen that the Panel2Sitting table 38 has a many to one relationship with each of the Panel table 35 and the Sitting table 37.

The Sitting table 37 includes an AssessableType field which identifies a record of the AssessableType table 39. The AssessableType table 39 defines different types of assessable objects (e.g. images) which can be used as a basis for the collection of scoring data. Different types of assessable objects are described below. It should however be noted that records of the AssessableType table 39 include a field indicating program code which is to be run to upload assessable objects of that type, and a field indicating program code which is to be run to cause display of assessable objects of that type so as to allow the collection of appropriate scoring data.

An Assessable table 40 stores data relating to a particular assessable object (e.g. an image) which is to be used as a basis for the collection of scoring data. The Assessable table 40 includes a field indicating a location at which the assessable object is stored. This location is specified using a URL. Records of the Assessable table 40 include a field identifying a record of the AssessableType table 39 so as to provide each assessable object with data indicating its type.

An AssessableMetaData table 41 stores metadata relating to assessable objects. A one-to-many relationship exists between the Assessable table 40 and the AssessableMetaData table 41, which means that many items of meta data may be stored for a single assessable object which is identified using its identifier.

The Sitting table 37 also has a one to many relationship with an AssessmentType table 42. The AssessmentType table 42 stores records defining different assessment types in terms of the way in which scoring data is to be collected, as described further below. Each record of the AssessmentType table 42 includes a field specifying a class which contains code arranged to cause collection of scoring data in the appropriate manner.

A ScoringSession table 43 is used to store records defining a scoring session. It can be seen that the ScoringSession table 43 has a many to one relationship with the Sitting table 37 such that each scoring session is associated with a single sitting, but a single sitting many have many associated scoring sessions. Records of the ScoringSession table 43 further include a field identifying a record of the Subscription table 36, thereby allowing a user associated with a particular scoring session to be identified.

Each scoring session comprises a plurality of scores. Each score is represented by a record of the Score table 44. It can be seen that the ScoringSession table 43 has a one-to-many relationship with the Score table 44, representing that each scoring session comprises a plurality of scores, and that each score is associated with a single scoring session. The Score table 44 has a one-to-one relationship with the ScoreValue table 45 which stores values of scores represented by records of the Score table 44.

Processing carried out by the described system to allow the collection of scoring data is now described.

FIG. 12 is a flowchart of processing carried out by a coordinator using the coordinator PC 2 (FIG. 1) to define a sitting and upload images associated with that sitting to the database 7. The processing of FIG. 12 uses a webpage shown in FIG. 13 to allow the coordinator to input appropriate data. The webpage of FIG. 13 is displayed in response to a request made via the web browser 21 running on the client 20. In this case, the coordinator PC 2 acts as the client 20.

At step S10 of FIG. 12 the coordinator inputs a name for the sitting in a name field 50. The name takes the form of a textual string which is used to allow easy human identification of the sitting. At step S11, the type of assessable object which is to be associated with the sitting is selected. As indicated above, the type of assessable object determines the type of images which are displayed to users during the scoring process and the manner of display. The type of assessable object is selected using a Session Type drop down list 51 provided by the webpage of FIG. 13. The Session Type drop down list 51 is populated by entries of the AssessableType table 39 (FIG. 11).

Session types are defined by the nature of the images displayed, and also the manner of display—for example display in a random order or display in an order specified by the coordinator. Options provided by the Session Type drop down list 51 are as follows:
Image Randomised: each score is based upon display of a single image, single images are displayed in a randomized order created by the server;
Image Specified: each score is based upon display of a single image, single images are displayed in an order specified by the coordinator;
Multi-Image randomised: each score is based upon display of a series of images, each of which may comprise two sub-images, as described above with reference to FIG. 3B; the order which the plurality of series of images is displayed is a randomized order created by the server.

Although in the described embodiment series of images used as a basis for a single score are displayed in a randomized order, it will be appreciated that in other embodiments a plurality of series of images may be displayed in an order specified by the coordinator.

Additionally, it will be appreciated that each single image referred to above may comprise two sub-images, so as to allow scoring data indicating a comparison between the sub-images to be obtained.

At step S12, an assessment type is selected using an AssessmentType drop down list 52. The selection of an assessment type determines the manner in which scoring data is to be input by an assessor. The AssessmentType drop down list 52 is populated with entries of the AssessmentType table 42 (FIG. 11). The drop down list 52 provides five options.

A first option relates to ranking of sub-images. That is, where a single image comprises two sub images, assessment data indicating which of the sub-images shows severest scarring may be obtained. Such data can be obtained using a user interface of the type shown in FIG. 14A. A tick-box 56a is selected to indicate than an image ‘A’ shows less severe scarring than an image ‘B’, a tick-box 56b is selected to indicate that images ‘A’ and ‘B’ show equally severe scarring, and a tick-box 56c is selected to indicate that the image ‘B’ shows less severe scarring than the image ‘A’.

A second option relates to the use of a visual analogue score, of the type described above with reference to FIG. 3A. Here, a single image shows a single scar. Data is obtained using a user interface of the type shown in FIG. 14B, which comprises a line 67. An assessor indicates a point on the line 57 to provide scoring data.

A third option relates to the use of a five point categorical score. In such a case scoring data relating to a single image showing a single scar is obtained, that data comprising a selection of one of five points defined on the scale. Such data can be obtained using a user interface of the type shown in FIG. 14C. Here, an assessor selects one of the tick boxes 58a to indicate the severity of scarring.

A fourth option relates to the use of a seven point categorical scale, of similar type to that of the third option described above. Such data can be obtained using a user interface of the type shown in FIG. 14D. Again, an assessor selects one of the tick boxes 58b to indicate the severity of scarring.

A fifth option relates to a comparative score of the type described above with reference to FIG. 3B. A suitable user interface for the collection of such data is shown in FIG. 14E.

During a scoring session, the interfaces of FIGS. 14A to 14E are used to input data by using an appropriate input device, such as, for example, a mouse which is used to control a pointer within a graphical user interface.

Code defining the interfaces shown in FIGS. 14A to 14E and described above is identified by appropriate records of the AssessmentType table 42.

The interfaces described above for the collection of scoring data may also comprise secondary data collection. More particularly, where the scoring data is comparative data (as in the case of the first and fifth options described above), secondary data collection may comprise collection of data indicating a clinical significance of a difference between the two images. Such significance, in one embodiment is determined by asking whether it is considered that the medicament that caused the improvement is worthy of use. A user interface configured to receive such input is shown in FIG. 14F, where an assessor uses one of the tick-boxes 59a, 59b to provide an answer to the displayed question. The use of such a question was described above in the context of tests carried out to determine the effectiveness of the scoring method described with reference to FIG. 3B.

Referring back to FIGS. 12 and 13, having selected an assessment type at step S12 using the Assessment Type drop down list 52, processing continues at step S13 where the coordinator indicates a maximum time which should be allocated for collection of data relating to a particular image, by entering a time (in seconds) into a text box 53. The input time determines the maximum time for which an image is displayed in an attempt to obtain scoring data without a timeout occurring.

At step S14 the coordinator specifies data relating to repeats of particular images using a text box 54. Particular images are repeated so as to monitor assessor consistency—that is, if a particular image is displayed twice, the data obtained in response to each display of the particular image can be compared to monitor assessor consistency. The text box 54 is arranged to receive an integer value indicating a number of times which images which are selected to be repeated should be shown. For example, where a value of ‘0’ is entered in the text box 54 images selected to be repeated are repeated once (i.e. each image to be repeated is shown twice). If a value of ‘1’ is entered in the text box 54 images selected to be repeated are repeated twice (i.e. each image to be repeated is shown three times).

Processing passes from step S14 to step S15 when the coordinator selects a ‘Next’ button 55. At step S15 assessable objects are uploaded to the server 6 for storage in the database 7 as described further below. At step S16 data representing the defined sitting is created, and the created data is stored in the sitting table 37 of the database 7 at step S17. Appropriate audit trail data is created at step S18 for storage in the database 7. At step S19, a report of the defined sitting is created and provided to the coordinator.

FIG. 15 shows processing carried out to upload assessable objects at step S23 of FIG. 12. Uploaded assessable objects are stored in the assessable table 40. At step S20 a file-system browser is displayed allowing the coordinator to view files stored on a storage device which is accessible to the computer which is being used by the coordinator. Such a storage device may be a local hard disk drive of the computer being used by the coordinator, a storage device available over a computer network, or a removable storage medium such as a CD-ROM, DVD or similar. The coordinator selects files from the storage device using the displayed file system browser at step S21. At step S22 the coordinator indicates which of the selected images should be repeated. This involves the display of a list of selected files. Each selected file is displayed with an associated tick box which can be selected to indicate that an image of a particular file should be repeated during scoring.

Processing passes from step S22 to step S23 where a first selected image is uploaded for storage in the database 7. A checksum for the uploaded image is created at step S24. If the uploaded image is to be repeated (as determined by the input of step S22) a repeat tag is associated with the uploaded image at step S26. The uploaded image, together with its checksum and repeat tag (where applicable) is stored in the database 7 at step S26.

Processing passes from step S26 to step S27. Here a check is carried out to determine whether further images are to be uploaded. If this is the case, processing passes from step S27 step S23. Otherwise, processing ends.

It was described with reference to FIG. 12, that after upload of images at step S15, a sitting definition is created at step S16. Two examples of creation of sitting definitions are now described with reference to FIGS. 16 and 17.

FIG. 16 shows creation of a sitting in which images are to be displayed in a randomized order. At step S30 a list of image identifiers is created based upon images specified by the coordinator. Identifiers of images which are to be repeated are appended to the list at step S31, such that the identifier of an image which is to be repeated appears twice in the created list. Elements of the created list are then arranged into a random order at step S32, before a data structure defining the sitting is created at step S33.

FIG. 17 shows creation of a sitting in which images are to be displayed in an order specified by a coordinator. At step S35 metadata associated with images which are to be displayed and indicating the specified order of display is read. This metadata is used to create an ordered list of images at step S36 which is used to create a sitting definition at step S37.

The preceding description has explained how a sitting is defined and how images to be displayed are associated with the created sitting. The described system further comprises functionality allowing a coordinator to remove a defined sitting from the database when the sitting is no longer of interest. Furthermore, while a sitting definition is usually stored together with data indicating that it is in an ‘active’ state, a coordinator can modify this data such that the sitting definition is stored together with data indicating that it is in an ‘inactive’ state. While in an active state, a sitting can be associated with a panel of assessors in the manner described in further detail below, while this cannot happen where the sitting is in an inactive state.

FIG. 18 is a screenshot of a webpage accessed by a coordinator to define a panel of assessors which is to provide scoring data. This webpage is again accessed by the coordinator using the coordinator computer 2 which acts as the client 20 of FIG. 9 and runs the web browser 21 to access the webpage of FIG. 18 which is provided as a JSP 24 by the servlet 23.

The webpage of FIG. 18 includes a text box 60 which a coordinator uses to allocate a name to the panel of assessors. A list 61 comprises names of a plurality of assessors defined in the system, each assessor having a corresponding record in the User table 34 (FIG. 11). Entries in the list 61 can be selected by the coordinator. Upon selection of an ‘Add’ button 62, the selected entries of the list 61 are added to a list 63 indicating assessors which are associated with the created panel. Similarly, assessors shown in the list 63 can be selected by the coordinator. The coordinator can then use a remove button 64 to remove assessors from the list 64, and return names of removed assessors to the list 61.

Alternatively, the coordinator may enter names of new assessors for which accounts are to be created in an area 65. Upon selection of a ‘Create’ button 66 the coordinator is prompted to input data (such as username and password) necessary to establish records in the User table 34 for each specified assessor. Having created appropriate records in the User table 34, details of the newly created assessors are added to the list 63.

The preceding description presented with reference to FIG. 18 has explained how a panel of assessors is defined. FIG. 19 shows a webpage presented to the coordinator to allow sittings to be associated with a particular panel. The webpage of FIG. 19 is displayed in response to selection of an ‘Add sittings’ button 67 in the webpage of FIG. 18.

Referring to FIG. 19, defined sittings are shown in a list 68. The coordinator can use an ‘Add’ button 69 to allocate sittings from the list 68 to the panel, in which case the selected sittings are added to a list 70 which shows sittings associated with the particular panel. Relationships between sittings and panels created using the interface of FIG. 19 are represented by records of the Panel2Sitting table 38.

Sittings included in the list 70 can be selected, and a ‘Remove’ button 71 can be used to remove the selected settings from the list 70 and reintroduce the selected sittings into the list 68.

If desired, the coordinator can use a link 72 to create a new sitting, in which case the webpage of FIG. 13 is displayed.

Having described processing carried out to define both sittings and panels, and processing carried out to define associations between sittings and panels, processing carried out to collect scoring data is now described with reference to the flowchart of FIG. 20. The processing of FIG. 20 is carried out by the server 6 in response to requests made by a computer used by an assessor which acts as the client 20 in the arrangement of FIG. 11. For example, the client 20 can be one of the user PC's 3,4 or can be the user laptop 5.

Referring to FIG. 20, at step S40 the assessor logs on to the system. This involves the assessor accessing a logon page provided by the server 6 using the web browser 21. Appropriate logon information in the form of a username and password is input to the logon page, and this logon information is transmitted to the server 6 for validation. It will be appreciated that subsequent processing may be made conditional upon correct validation of the provided user name and password.

Having logged on to the system in the described way at step S40, at step S41 a plurality of panels are displayed to the assessor for selection. The panels may be defined in any convenient way but will typically be arranged such that different panels can be easily identified by a user in the context of tests being carried out. Panels to be displayed to a user at step S41 are obtained by appropriately querying the database 7. More specifically, the Subscription table 36 is queried using the identifier of the assessor (determined using the logon information) and this query identifies one or more records of the Panel table 35 which are associated with the identified assessor. The records of the Panel table 35 returned by the query are used to generate data indicating panels to be displayed at step S41.

Upon selection of one of the displayed panels at step S42, processing passes to step S43 where a list of sittings is presented to the assessor for selection. This list of sittings is again generated using data stored in the database 7. More particularly, the Panel2Sitting table 38 is queried using a panel identifier determined by the selection made at step S42. This query identifies one or more records of the Sitting table 37 which are used to generate a list of sittings for display at step S43. The assessor selects one of the displayed sittings at step S44.

At step S45 a check is carried out to determine whether a scoring session exists which is associated with both the selected sitting and the assessor. This check involves querying the ScoringSession table 43. If it is determined that no scoring session exists, processing passes to step S46. Here the sitting definition is obtained from the Sitting table 37 of the database 7. A scoring session is created at step S47 and data defining the created scoring session is saved in the ScoringSession table 43 at step S48. At step S49, the scoring session begins.

If the check of step S45 indicates that a scoring session exists, processing passes to step S50. Here a check is carried out to determine whether the extant scoring session was started more than 24 hours previously. If the extant scoring session was started less than 24 hours previously, this session is continued and processing passes to step S52 (described further below).

If however it is determined that the scoring session was started more than 24 hours previously, processing passes from step S50 to step S51 where the appropriate record of the Scoring Session table 43 is marked as timed out, before processing continues at step S46.

Processing passes from step S49 to step S52. At step S52 a next image is obtained from the database 7. At step S53 a checksum for the image obtained from the database is determined and compared with the checksum stored in the database 7 to ensure that the downloaded image is not corrupt. If the downloaded image is corrupt, appropriate corrective action is taken. The downloaded image is then displayed to the assessor at step S54, and scoring is enabled at step S55. The enabling of scoring involves the display of an appropriate user interface (as shown in FIGS. 14A to 14E) which is dependent upon the nature of the scoring data being collected. The assessor interacts with the displayed user interface, and the generated score is stored in the database 7, in appropriate records of the Score table 44 and the ScoreValue table 45 at step S56.

Processing passes from step S56 to step S57. At step S57 a check is carried out to determine whether further images remain to be displayed. If this is the case, processing returns to step S52. Otherwise, processing passes from step S57 to step S58 where the appropriate records of the ScoringSession table 58 are appropriately updated, before the assessor is informed that scoring is complete at step S59.

In the processing of FIG. 20, the display of the image at step S54 will, in some cases, involve the display of a series of images as described above with reference to FIG. 3B. More particularly, a series of images of the same scar or scars may be displayed in an order determined by time between wounding and generation of the image.

It was described above that the coordinator may specify a maximum time for which an image should be displayed for the purposes of obtaining scoring data. The processing of step S54 may therefore include a timeout mechanism configured to monitor elapsed time since display of the image, and to stop display of the image if a predetermined time is reached without scoring data having been received.

The display of images at step S54 is carefully controlled. For example display screens upon which images are to be displayed are calibrated in advance in respect of parameters such as brightness and contrast so as to ensure that scoring data obtained from images displayed on different display screens can be reliably compared. Additionally, prior to display of an image at step S54, an applet within the webpage displaying the image is arranged to determine the image size and to display the image if but only if the image size is not greater than the size of an area in which the image is to be displayed on the webpage. Otherwise the image is resized prior to display in such a way that the aspect ratio of the image is maintained.

Having described various ways of collecting scoring data by displaying images and collecting scoring data relating to those displayed images, a system is now described in which collection of data is not limited to that based upon displayed images, but can also be based upon physical scar casts. Each image has an associated physical scar cast which is a plaster cast of a scar shown in the image. Such plaster casts are generated from negative silicone mould impressions of scars. Briefly, liquid silicone is moulded over the scar and allowed to set before being removed. The removed silicone acts as a mould and is labelled with an appropriate identifier identifying the scar. A positive plaster cast impression is generated by filling the silicone mould with dental plaster which is allowed to set. Techniques for the creation of plaster casts of scars are described in: Nedelec B, Shankowsky H A and Tredgett E E (2000): “Rating the resolving hypertrophic scar: comparison of the Vancouver Scar Scale and scar volume”, J Burn Care Rehabil. 21(3):205-12, the contents of which are incorporated herein by reference.

Methods are now described for uploading images associated with scar casts to the database 7, and for collecting scoring data based upon such images and the scar casts.

FIG. 21 is a flowchart of a process for uploading images associated with physical scar casts to the database 7. The processing of FIG. 21 is carried out at step S15 of FIG. 12, when the assessable type is set at step S11 to indicate the use of physical casts. The processing of FIG. 21 uses a user interface shown in FIG. 22 which is presented within a frame of a webpage in the form of, for example, a Java applet.

At step S70 the coordinator selects a ‘Browse’ button 75 to cause display of a file system browser which can be used, at step S71, to select files which are to be uploaded to the database 7 in the general manner described above with reference to FIG. 15. Files selected using the file system browser are displayed at step S72 in an area 76. It can be seen that the area 76 displays a filename 77, a size 78, and a directory 79 for each file. At step S73 the coordinator can indicate particular files which are to be repeated during a scoring session by using a tickbox 80 provided for each file listed in the area 76.

At step S74 the coordinator enters a cast identifier for each image in an area 81. The cast identifiers are attached or affixed to the relevant scar casts and are read by the coordinator for input to the area 81.

The user interface of FIG. 22 further allows files shown in the area 76 to be selected by a user and a ‘Remove Selected’ button 82 can be selected to cause removal of selected files from the area 76. A ‘Remove All’ button 83 can be selected to cause removal of all files included in the area 76.

Having selected appropriate files, specified repeats, and input cast identifiers in the manner described above, a user then selects an ‘Upload’ button 84 at step S75 to cause upload of files listed in the area 76. The upload of images is carried out by processing similar to that described above with reference to FIG. 15. More specifically, steps S76 to S80 of FIG. 21 generally respectively correspond to steps S23 to S27 of FIG. 15, and cause the upload of files to the database 7. It will however be appreciated that in this case the upload of files further includes the upload of the input cast identifiers.

The user interface of FIG. 22 further comprises a progress bar 85 which shows progress of file upload operations, and a ‘Stop’ button 86 which allows the uploading of files to be stopped.

The server 6 is arranged to generate a corresponding barcode identifier for each input cast identifier. A report indicating relationships between cast identifiers and barcode identifiers is generated and provided at step S81. Appropriate barcode identifiers are then generated and affixed to the correct scar casts for use in scoring sessions, as described further below.

It was indicated above that images may be displayed in a coordinator specified order or in a random order. This is determined by the selection of the assessable type at step S11 of FIG. 12. If images are to be displayed in a coordinator specified order, the user interface of FIG. 23 is displayed before the images are uploaded to the database 7.

The user interface of FIG. 23 comprises an area 87 in which a list of images is displayed. Images in the area 87 can be selected by a coordinator and an ‘Up’ button 88 and a ‘Down’ button 89 can be used to alter the order in which images are displayed in the area 87, thereby altering the order in which images are displayed during a scoring session.

The processing carried out during a scoring session has been described above with reference to FIG. 20. Where scoring is to be based upon physical scar casts (in addition to images), the general arrangement used is shown in FIG. 24. It can be seen that the user PC 3 is shown connected to the network 1 as described above, and that the server 6 is also connected to the network 1. Although the arrangement of FIG. 24 is described with reference to the user PC 3 it will be appreciated that use of the user PC 4 or the user laptop 5 is similar.

The user PC 3 is connected to a barcode reader 90 of conventional form. An assessor is provided with a plurality of physical scar casts 91. Each physical scar cast has a barcode identifier 92 affixed thereto which is readable by the barcode reader 90. In this way an assessor can scan a barcode identifier 92 so as to identify a physical scar cast to the system, as described below.

FIG. 25 is a flowchart showing processing carried out at step S54 of FIG. 20 where a physical scar cast is associated with an image to be displayed. At step S85 a check is carried out to ensure that the image is of a size such that it can be displayed within the allocated display area. If this is not the case, processing passes to step S86 where the image is resized while its aspect ratio is maintained, before processing passes to step S87. If the image is of a size such that it can be displayed within the allocated display area, processing passes directly from step S85 to step S87.

At step S87 the assessor is prompted to scan a barcode identifier associated with the physical scar cast which the assessor believes is associated with the appropriate image. This can be achieved by a coordinator providing the physical scar casts to the assessor in what is believed to be the correct order, the correct order being determined with reference to a report provided to the coordinator indicating the order in which the physical scar casts should be provided. The assessor is prompted to scan a barcode by display of a dialog box having a form shown in FIG. 26. The appropriate barcode identifier is scanned using the barcode reader 90, and a value associated with the scanned barcode is shown in a text box 95. The assessor then selects an OK button 96 to cause the scanned barcode to be processed.

At step S88 a check is carried out to determine whether the image to be displayed and the barcode identifier scanned at step S87 match, as defined by data stored in the database 7. If the barcode identifier matches the image to be displayed, the image is displayed at step S89 so that scoring data can be collected in the manner described above. If the barcode identifier does not match the image to be displayed, processing passes to step S90 where an appropriate message is displayed to the assessor, before processing returns to step S86 and continues as described above.

It will be appreciated that the processing described above can be carried out for any scoring method in which images are displayed in an order determined by data stored in the database 7, regardless of whether that order is determined by coordinator input or is a random order generated by the server 6.

The described system also supports the collection of scoring data using physical scar casts in a different way. This is described with reference to a flowchart shown in FIG. 27.

At step S91 the user is prompted to scan the barcode identifier 92 of any physical cast 91 which the user believes is to be used as a basis for scoring. This is achieved by the display of the dialog box shown in FIG. 26 and described above. At step S92 the user scans a barcode identifier. The scanned barcode identifier is processed at step S93 to determine whether it is recognised. This involves determining whether the scanned barcode identifier is stored in the AssessableMetadata table 41 of the database 7. If the barcode identifier is not recognised, processing passes to step S94 where the assessor is appropriately informed by display of a dialog box shown in FIG. 28 which prompts the assessor to scan a barcode identifier, and processing returns to step S91.

If the scanned barcode identifier is recognised at step S93 processing passes to step S95 where it is determined whether scoring data associated with the image associated with the scanned barcode identifier is required. If this is not the case, processing passes to step S96 where the assessor is appropriately informed, before processing returns to step S91. Otherwise, processing passes from step S95 to step S97. At step S97 the image associated with the scanned barcode is downloaded from the database 7. At step S98 its size is checked in the manner described above. If the check indicates that the size is in order, processing passes to step S99 where the image is displayed. Otherwise, processing to step S100 where the image is rescaled before display.

The preceding description has explained how a collection images can be associated with a plurality of assessors so as to obtain scoring data indicating the severity of scars shown in the images. It will be appreciated that when such data has been collected and stored in the database 7, such data can be used to generate reports indicating and summarising the scoring data which has been collected.

Various methods of collecting scoring data have been described. One method was described above with reference to FIG. 3B, and experiments showing its benefits have also been set out above. It will be appreciated that the method of collecting scoring data as described with reference to FIG. 3B is in no way limited to the use of the described computer system. For example, in some embodiments scoring data is collected using the methods described with reference to FIG. 3B using an appropriate questionnaire which can be completed by a patient or by medical staff treating the patient. The questionnaire includes a scale similar to the scale 12 of FIG. 3B.

It will be appreciated that the embodiments of the invention described above are intended to be, in all respects, illustrative, and in no way restrictive. It will be appreciated that various modifications may be made to the embodiments of the invention described above. For example, although an exemplary network of computers is shown in FIG. 1, it will be appreciated that various modifications can be made to that network. Furthermore, it will be understood that any suitable computing devices can be connected to the network 1 to carry out the operations described above. As such the terms PC, laptop and server as used herein should be construed broadly so as to include any suitable computing device.

It will be appreciated that various modifications can be made to the described embodiments without departing from the spirit and scope of the invention set out in the appended claims.

What is claimed is:

1-76. (canceled)

77. A method of determining the efficacy of a medicament for the treatment of wounds or scars, the method comprising:
selecting first and second scarring site portions, wherein said first scarring site portion has been treated with said medicament;
generating a pair of images comprising a first image of said first scarring site portion and a second image of said second scarring site portion;
displaying said pair of images;
providing a recording element comprising first and second recording portions, wherein said first recording portion comprises a plurality of first points indicating that scarring in said first image is less severe than scarring in said second image, and said second recording portion comprises a plurality of second points indicating that scarring in said second image is less severe than scarring in said first image, each of said first and second points having different associated values; and
receiving data identifying one of said points and using said data to determine the efficacy of said medicament.

78. A method according to claim 77, further comprising:
wherein said second scarring site portion has been treated with a control treatment.

79. A method according to claim 77, wherein said first and second images are displayed simultaneously.

80. A method according to claim 79, wherein said recording element is displayed such that said first recording portion of said recording element is aligned with said first image and such that said second recording portion of said recording element is aligned with said second image.

81. A method according to claim 80, wherein said first and second images are displayed alongside and abutting one another in an image display portion, and wherein said recording element extends along said image display portion such that said first recording portion of said recording element is aligned with said first image and such that said second recording portion of said recording element is aligned with said second image.

82. A method according to claim 81, wherein said recording element further comprises a third recording portion comprising a third point indicating that each of said first and second images show equally severe scarring, said third point being aligned with a line along which said first and second images abut one another.

83. A method according to claim 82, wherein:
said values associated with said first points define a range of values extending from a first limit value indicating that scarring in said first image is markedly less severe than scarring in said second image to a second limit value indicating that scarring in said first image is marginally less severe than scarring in said second image; and
said values associated with said second points define a range of values extending from a third limit value indicating that scarring in said second image is markedly less severe than scarring in said first image to a fourth limit value indicating that scarring in said second image is marginally less severe than scarring in said first image.

84. A method according to claim 83, wherein said second and fourth limit values are associated with respective points of the recording element which are adjacent said third recording portion of said recording element, and wherein said first and third limit values are associated with respective points of the recording element which are distant from said third recording portion of said recording element.

85. A method according to claim 77, wherein each of said first and second images are images of the skin of a common subject.

86. A method according to claim 77 wherein said first and second images were created at a first common time defined with reference to a start time, said start time being defined with reference to at least one of wounding and treatment of a scar.

87. A method according to claim 86, further comprising, before displaying said first and second images:
displaying an ordered plurality of image pairs, a first image of each image pair being an image of said first scarring site portion, and a second image of each image pair being an image of a second scarring site portion;
wherein each image of an image pair is displayed simultaneously; and
wherein each of said image pairs comprises images of said first and second scarring site at a respective common time defined with reference to said start time.

88. A method according to claim 87, wherein said plurality of image pairs are ordered with reference to said respective common times, and wherein said respective common times are shorter than said first common time.

89. A method according to claim 77, wherein said recording element comprises a line, said first recording portion is a first portion of said line, and said second recording portion is a second portion of said line.

90. A method according to claim 77, further comprising, after obtaining data indicating one of said first points:
presenting a question relating to clinical significance of said received data; and
receiving a response to the presented question.

91. A method according to claim 77, further comprising creating at least one wound which forms said first and second scarring site portions.

92. A method according to claim 77, wherein said first and second scarring site portions are portions of a common scar.

93. A method according to claim 77, wherein said first and second scarring site portions are portions of different scars.

94. A method of determining the efficacy of a medicament for the treatment of wounds or scars, the method comprising:
selecting first and second scarring site portions wherein said first scarring site portion has been treated with said medicament;
at each of a plurality of predetermined times, generating a pair of images comprising a first image of said first scarring site portion and a second image of said second scarring site portion;
consecutively displaying said pairs of images, the pairs of images being displayed in an order determined by times at which the pairs of images were generated;
providing a user input element comprising first and second recording portions, wherein said first recording portion comprises a plurality of first points indicating that scarring in said first image is less severe than scarring in said second image, and said second recording portion comprises a plurality of second points indicating that scarring in said second image is less severe than scarring in said first image, each of said first and second points having different associated values;
receiving user input identifying one of said points; and
generating comparative data based upon said user input, said comparative data being used to determine the efficacy of said medicament.

95. A method according to claim 94, wherein said predetermined times are defined with reference to at least one of wounding and treatment of a scar.

96. A method according to claim 94, wherein said second scarring site portion has been treated with a control treatment.

97. A method of determining the efficacy of a medicament for the treatment of wounds or scars, the method comprising:
selecting first and second scarring site portions wherein said first scarring site portion has been treated with said medicament;
providing a recording element comprising first and second recording portions, wherein said first recording portion comprises a plurality of first points indicating that scarring in said first scarring site portion is less severe than scarring in said second scarring site portion, and said second portion comprises a plurality of second points indicating that scarring in said second scarring site portion is less severe than scarring in said first scarring site portion, each of said first and second points having different associated values; and
receiving data identifying one of said points and using said data to determine the efficacy of said medicament.

98. A method of generating comparative data indicating a comparison between severity of scarring in two images, the method comprising:
displaying first and second images, each of said first and second images being an image of human or animal skin which includes a scar;
displaying a user input element comprising first and second portions, wherein said first portion comprises a plurality of first points indicating that scarring in said first image is less severe than scarring in said second image, and said second portion comprises a plurality of second points indicating that scarring in said second image is less severe than scarring in said first image, each of said first and second points having different associated values;
receiving user input identifying one of said points; and
generating comparative data based upon said user input.

99. A method according to claim 98, wherein said first and second images are displayed simultaneously and said user input element is displayed such that said first portion of said user input element is aligned with said first image and such that said second portion of said user input element is aligned with said second image.

100. A method according to claim 99, wherein said first and second images are displayed alongside and abutting one another in an image display portion and said user input element extends along said image display portion such that said first portion of said user input element is aligned with said first image and such that said second portion of said user input element is aligned with said second image.

101. A method according to claim 98, wherein said, user input element further comprises a third portion comprising a third point indicating that each of said first and second images show equally severe scarring, and said third point is aligned with a line along which said first and second images abut one another.

102. A method according to claim 101, wherein:
said values associated with said first points define a range of values extending from a first limit value indicating that scarring in said first image is markedly less severe than scarring in said second image to a second limit value indicating that scarring in said first image is marginally less severe than scarring in said second image; and
said values associated with said second points define a range of values extending from a third limit value indicating that scarring in said second image is markedly less severe than scarring in said first image to a fourth limit value indicating that scarring in said second image is marginally less severe than scarring in said first image.

103. A method according to claim 102, wherein said second and fourth limit values are associated with respective points of the user interface element which are adjacent said third portion of said user input element and said first and third limit values are associated with respective points of the user interface element which are distant from said third portion of said user input element.

104. A method according to claim 98, wherein said first image includes first scar at a first predetermined time and said second image includes a second scar at said first predetermined time.

105. A method according to claim 104, further comprising, before displaying said first and second images:
displaying an ordered plurality of image pairs, a first image of each image pair being an image of said first scar, and a second image of each image pair being an image of a second scar; and
wherein each image of an image pair is displayed simultaneously.

106. A method according to claim 105, wherein each of said image pairs comprises images of said first and second scars at a respective predetermined time, and said plurality of image pairs is ordered with reference to said respective predetermined times, and said respective predetermined times are shorter than said first predetermined time.

107. A method according to claim 98, wherein the or each predetermined time is defined with reference to at least one of creation of a scar and treatment of a scar.

108. A computer-implemented method of generating comparative data, the method comprising:
displaying first and second images on a display device associated with the computer, each of said first and second images being an image of human or animal skin which includes a scar;
displaying a user input element comprising first and second portions on said display device, wherein said first portion comprises a plurality of first points indicating that scarring in said first image is less severe than scarring in said second image, and said second portion comprises a plurality of second points indicating that scarring in said second image is less severe than scarring in said first image, each of said first and second points having different associated values;
receiving at the computer user input identifying one of said points; and
generating at the computer comparative data based upon said user input.

109. A computer readable medium carrying a computer program comprising computer readable instructions to control a computer to carry out a method according to claim 98.

110. A computer apparatus arranged to collect comparative data, the apparatus comprising:
a memory storing processor readable instructions; and
a processor configured to read and execute instructions stored in said memory, and
wherein said processor readable instructions comprise instructions configured to control the computer to carry out the method of claim 98.

111. A method for collecting comparative data relating to the relative severity of scarring in first and second scar portions, the method comprising:
providing a recording element comprising first and second recording portions, wherein said first recording portion comprises a plurality of first points indicating that scarring in said first scar portion is less severe than scarring in said second scar portion, and said second recording portion comprises a plurality of second points indicating that scarring in said second scar portion is less severe than scarring in said first scar portion, each of said first and second points having different associated values; and
recording data indicating one of said points to collect said comparative data.

112. A method according to claim 111, wherein said recording element is provided on a medium upon which said data is recorded.

113. A method according to claim 111, wherein said recording element comprises a line, said first portion is a first portion of said line, and said second portion is a second portion of said line.

114. A method according to claim 111, wherein said first and second scar portions are portions of the same scar.

115. A method according to claim 111, wherein said first and second scar portions are portions of different scars.

116. A tangible medium for collecting comparative data relating to the relative severity of scarring in first and second scar portions, the medium comprising a scale comprising first and second recording portions, wherein said first recording portion comprises a plurality of first points indicating that scarring in said first scar portion is less severe than scarring in said second scar portion, and said second recording portion comprises a plurality of second points indicating that scarring in said second scar portion is less severe than scarring in said first scar portion, each of said first and second points having different associated values.

117. A method of obtaining data indicating a severity of scarring in human or animal skin in response to wounding of said human or animal skin, the method comprising:
displaying at least one first image of said human or animal skin, the or each first image being an image of a scar formed at a respective first time after wounding of said human or animal skin;
displaying a second image of said human or animal skin, said second image being an image of a scar formed at a second time after wounding of said human or animal skin, wherein said second time is longer than the or each first time; and
receiving as input data indicating the severity of scarring in said human or animal skin in response to display of said second image.

118. A method according to claim 117, wherein the at least one first image and said second image are displayed consecutively.

119. A method according to claim 117, comprising displaying a plurality of first images, wherein said plurality of first images are displayed consecutively.

120. A method according to claim 119, wherein each of said first images is an image of a scar formed at a respective time, and said first images are displayed consecutively such that each first image is displayed before any first image of a scar formed at a longer time after wounding.

121. A method according to claim 117, wherein each of said first and second images comprises a pair of sub-images.

122. A method according to claim 121, wherein said input data indicating the severity of scarring in said human or animal skin comprises comparative data indicating a comparison between scarring in said sub-images.

123. A method according to claim 121, wherein each sub-image of a pair of a sub-images is an image of the skin of a common subject.

124. A method according to claim 123, wherein a first image of each pair of images is an image of a first scar treated with a first predetermined substance, the first predetermined substance being a medicament whose efficacy is being investigated.

125. A method according to claim 123, wherein a second image of each pair of images is an image of a second scar treated with a control treatment.

126. A computer readable medium carrying a computer program comprising computer readable instructions to control a computer to carry out a method according to claim 117.

127. A computer apparatus arranged to collect comparative data, the apparatus comprising:
a memory storing processor readable instructions; and
a processor configured to read and execute instructions stored in said memory;
wherein said processor readable instructions comprise instructions configured to control the computer to carry out the method of claim 117.
